(19) United States
(12) Patent Application Publication
(10) Pub. No.: US 2025/0292284 A1
(43) Pub. Date: Sep. 18, 2025

(54) System and Method to Measure the Performance of an Online Advertisement and Update the Control Group in Real Time

(71) Applicant: LoopMe, Ltd., London (GB)

(72) Inventors: Leonard Newnham, Calvert (GB); Yuliia Loktionova, London (GB)

(73) Assignee: LoopMe, Ltd., London, EN (GB)

(21) Appl. No.: 18/607,889

(22) Filed: Mar. 18, 2024

(51) Int. Cl. G06Q 30/0242; G06Q 30/08

(52) U.S. Cl. CPC G06Q 30/0242; G06Q 30/0275

(57) ABSTRACT

A measurement platform configured to measure performance of an advertisement, the measurement platform comprising a demand-side platform (DSP), the measurement platform configured to send to an end user a survey configured to measure the advertisement's performance on behalf of a client DSP, wherein the measurement platform is further configured to update an exposed group of exposed users, wherein the measurement platform is further configured to update a control group of end users with similar statistical properties to the exposed group except that the control users have not seen the winning advertisement, wherein the measurement platform is further configured to send the survey to the end user, wherein the measurement platform is further configured to receive a survey response from the end user, wherein the measurement platform determines a metric measuring performance of the winning advertisement, wherein the measurement platform is further configured to send the metric to the client DSP.

### SUMMARY

A measurement platform configured to measure performance of an advertisement, the measurement platform comprising a demand-side platform (DSP), the measurement platform configured to send to an end user a survey configured to measure the advertisement's performance on behalf of a client DSP, the client DSP comprising a DSP of a client of the measurement platform, wherein the measurement platform is further configured to receive an advertisement display notification, the advertisement display notification notifying the measurement platform that a device under control of the end user (“user device”) has displayed to the end user a winning advertisement from the client DSP that wins an auction run by a supply-side platform (SSP) operably connected to the DSP, the advertisement display notification comprising an identifier of the end user, wherein on receipt of the advertisement display notification, the measurement platform stores the identifier of the exposed end user (“exposed user identifier”) in an exposed group of end users (“exposed users”) that have seen the winning advertisement, wherein the measurement platform is further configured to update an exposed group of the exposed users, wherein the measurement platform is further configured to update a control group of end users with similar statistical properties to the exposed group except that the control group members (“control users”) have not seen the winning advertisement, wherein the measurement platform is further configured to send the survey to the end user, wherein the measurement platform is further configured to receive a response to the survey from the end user, wherein the measurement platform is further configured to determine a metric measuring performance of the winning advertisement, wherein the measurement platform is further configured to send the metric to the client DSP.

A method for measuring effectiveness of an advertisement using a measurement platform, the method comprising: receiving, by the measurement platform, the measurement platform configured to measure performance of an advertisement, the measurement platform comprising a demand-side platform (DSP), the measurement platform further comprising a profile storage configured to store an end user profile, the end user profile comprising a set of features associated with the end user, the measurement platform further comprising a control group storage configured to store an identifier of a control user (“control user identifier”), the measurement platform further comprising a control group builder operably connected to the data platform, the control group builder configured to update the control group with similar statistical properties to an exposed group of end users (“exposed users”) that have seen the winning advertisement, an advertisement display notification notifying the measurement platform that a device under control of the end user (“user device”) has displayed to the end user a winning advertisement from a client DSP, the client DSP comprising a DSP of a client of the measurement platform, the winning advertisement having won an auction run by a supply-side platform (SSP) operably connected to the DSP, the advertisement display notification comprising an identifier of the end user; storing, by the measurement platform, the identifier of the exposed end user (“exposed user identifier”) in the exposed group; updating, by the measurement platform, the exposed group; updating, by the control group builder, with a new control user identifier, a control group of end users with similar statistical properties to the exposed group except that the control group members (“control users”) have not seen the winning advertisement; storing, by the control group builder, the identifier of the new control user (“control user identifier”) in the control group storage; receiving, by the measurement platform, an advertisement request copy from the SSP; sending, by the measurement platform, to the end user, a survey configured to measure performance of the advertisement; receiving, by the measurement platform, a response to the survey from the end user; determining, by the measurement platform, a metric measuring performance of the winning advertisement; and sending, by the measurement platform, the metric to the client DSP.

A method for measuring effectiveness of an advertisement using a measurement platform, the method comprising: receiving, by the measurement platform, the measurement platform configured to measure performance of an advertisement, the measurement platform comprising a demand-side platform (DSP), the measurement platform further comprising a profile storage configured to store an end user profile, the end user profile comprising a set of features associated with the end user, the measurement platform further comprising a control group storage configured to store an identifier of a control user (“control user identifier”), the measurement platform further comprising a control group builder operably connected to the data platform, the control group builder configured to update the control group with similar statistical properties to an exposed group of end users (“exposed users”) that have seen the winning advertisement, an advertisement display notification notifying the measurement platform that a device under control of the end user (“user device”) has displayed to the end user a winning advertisement from a client DSP, the client DSP comprising a DSP of a client of the measurement platform, the winning advertisement having won an auction run by a supply-side platform (SSP) operably connected to the DSP, the advertisement display notification comprising an identifier of the end user; storing, by the measurement platform, the identifier of the exposed end user (“exposed user identifier”) in the exposed group; updating, by the exposed group storage, the exposed group; retrieving, by the control group builder, a selected portion of the exposed user identifiers; retrieving, by the control group builder, a selected portion of the control user identifiers; retrieving, by the control group builder, a selected portion of the end user profiles comprised in the profile storage; encoding, by the control group builder, an end user profile into a binary feature vector, wherein at least one element of the binary feature vector equals 0 or 1; sorting, by the control group builder, the binary feature vector into one of a group comprising exposed binary feature vectors (“an exposed binary feature vector group”), a group comprising control binary feature vectors (“a control binary feature vector group”), and a control pool comprising all available binary feature vectors that are not comprised in one or more of the exposed binary feature vector group and the control binary feature vector group; determining, by the control group builder, using the exposed binary feature vector group and using the control binary feature vector group, an actual index vector, the actual index vector comprising a measure of a difference between the binary feature vectors corresponding to the exposed users (“exposed binary feature vectors”) and the binary feature vectors corresponding to the control users (“control binary feature vectors”); determining, by the control group builder, a dot product between the actual index vector and a binary feature vector comprised in the control pool; storing, by the control group builder, the dot product in the control group storage; selecting, by the control group builder, a best control binary feature vector having a maximum value of the dot product; transferring, by the control group builder, the best control binary feature vector from the control pool to the control group; storing, by the control group builder, the identifier of the new control user (“control user identifier”) in the control group storage; determining, by the measurement platform, that a size of the control group does not comprise at least a required control group size; and returning, by the measurement platform, to the step of retrieving all available exposed user identifiers.

A method for measuring effectiveness of an advertisement using a measurement platform, the method comprising: receiving, by the measurement platform, the measurement platform configured to measure performance of an advertisement, the measurement platform comprising a demand-side platform (DSP), the measurement platform further comprising a profile storage configured to store an end user profile, the end user profile comprising a set of features associated with the end user, the measurement platform further comprising a control group storage configured to store an identifier of a control user (“control user identifier”), the measurement platform further comprising a control group builder operably connected to the data platform, the control group builder configured to update the control group with similar statistical properties to an exposed group of end users (“exposed users”) that have seen the winning advertisement, an advertisement display notification notifying the measurement platform that a device under control of the end user (“user device”) has displayed to the end user a winning advertisement from a client DSP, the client DSP comprising a DSP of a client of the measurement platform, the winning advertisement having won an auction run by a supply-side platform (SSP) operably connected to the DSP, the advertisement display notification comprising an identifier of the end user; storing, by the measurement platform, the identifier of the exposed end user (“exposed user identifier”) in the exposed group; updating, by the exposed group storage, the exposed group; retrieving, by the control group builder, a selected portion of the exposed user identifiers; retrieving, by the control group builder, a selected portion of the control user identifiers; retrieving, by the control group builder, a selected portion of the end user profiles comprised in the profile storage; encoding, by the control group builder, an end user profile into a binary feature vector, wherein at least one element of the binary feature vector equals 0 or 1; sorting, by the control group builder, the binary feature vector into one of a group comprising exposed binary feature vectors (“an exposed binary feature vector group”), a group comprising control binary feature vectors (“a control binary feature vector group”), and a control pool comprising all available binary feature vectors that are not comprised in one or more of the exposed binary feature vector group and the control binary feature vector group; determining, by the control group builder, using the exposed binary feature vector group and using the control binary feature vector group, an actual index vector, the actual index vector comprising a measure of a difference between the binary feature vectors corresponding to the exposed users (“exposed binary feature vectors”) and the binary feature vectors corresponding to the control users (“control binary feature vectors”); determining, by the control group builder, a dot product between the actual index vector and a binary feature vector comprised in the control pool; storing, by the control group builder, the dot product in the control group storage; selecting, by the control group builder, a best control binary feature vector having a maximum value of the dot product; transferring, by the control group builder, the best control binary feature vector from the control pool to the control group; storing, by the control group builder, the identifier of the new control user (“control user identifier”) in the control group storage; determining, by the measurement platform, that a size of the control group comprises at least a required control group size; receiving, by the measurement platform, an advertisement request copy from the SSP; sending, by the measurement platform, to the SSP a measurement platform bid that wins the auction, the measurement platform bid comprising an amount of money the measurement platform offers to pay for the opportunity to display on the user device a survey configured to measure on behalf of the client DSP performance of the winning advertisement the measurement platform bid further comprising the survey; sending, by the measurement platform, the survey to the end user; receiving, by the measurement platform, a response to the survey from the end user; determining, by the measurement platform, a metric measuring performance of the winning advertisement; and sending, by the measurement platform, the metric to the client DSP.

A method for measuring effectiveness of an advertisement using a measurement platform, the method comprising: receiving, by the measurement platform, the measurement platform configured to measure performance of an advertisement, the measurement platform comprising a demand-side platform (DSP), the measurement platform further comprising a profile storage configured to store an end user profile, the end user profile comprising a set of features associated with the end user, the measurement platform further comprising a control group storage configured to store an identifier of a control user (“control user identifier”), the measurement platform further comprising a control group builder operably connected to the data platform, the control group builder configured to update the control group with similar statistical properties to an exposed group of end users (“exposed users”) that have seen the winning advertisement, an advertisement display notification notifying the measurement platform that a device under control of the end user (“user device”) has displayed to the end user a winning advertisement from a client DSP, the client DSP comprising a DSP of a client of the measurement platform, the winning advertisement having won an auction run by a supply-side platform (SSP) operably connected to the DSP, the advertisement display notification comprising an identifier of the end user; storing, by the measurement platform, the identifier of the exposed end user (“exposed user identifier”) in the exposed group; updating, by the exposed group storage, the exposed group; retrieving, by the control group builder, a selected portion of the exposed user identifiers; retrieving, by the control group builder, a selected portion of the control user identifiers; retrieving, by the control group builder, a selected portion of the end user profiles comprised in the profile storage; encoding, by the control group builder, using one-hot encoding, an end user profile into a binary feature vector, wherein at least one element of the binary feature vector equals 0 or 1; sorting, by the control group builder, the binary feature vector into one of a group comprising exposed binary feature vectors (“an exposed binary feature vector group”), a group comprising control binary feature vectors (“a control binary feature vector group”), and a control pool comprising all available binary feature vectors that are not comprised in one or more of the exposed binary feature vector group and the control binary feature vector group; determining, by the control group builder, using the exposed binary feature vector group and using the control binary feature vector group, an actual index vector, the actual index vector comprising a measure of a difference between the binary feature vectors corresponding to the exposed users (“exposed binary feature vectors”) and the binary feature vectors corresponding to the control users (“control binary feature vectors”), using an equation (1):

$$actual\_index {\_vector}_{i} = ln ( \frac{( {expCount}_{i}^{⋆} numConBFVectors )}{( {conCount}_{{i}^{⋆}} numExpBFVectors )} ) , \qquad ( 1 )$$

wherein:
expCountᵢ=a count of 1's comprised in an ith element of the exposed binary feature vector;
conCountᵢ=a count of 1's comprised in respective ith element of the control binary feature vectors;
numConBFVectors=number of binary feature vectors comprised in the control group; and
numExpBFVectors=number of binary feature vectors comprised in the exposed group;
   determining, by the control group builder, a dot product between the actual index vector and a binary feature vector comprised in the control pool; storing, by the control group builder, the dot product in the control group storage; selecting, by the control group builder, a best control binary feature vector having a maximum value of the dot product; transferring, by the control group builder, the best control binary feature vector from the control pool to the control group; storing, by the control group builder, the identifier of the new control user (“control user identifier”) in the control group storage; determining, by the measurement platform, that a size of the control group does not comprise at least a required control group size; and returning, by the measurement platform, to the step of retrieving all available exposed user identifiers.

A method for measuring effectiveness of an advertisement using a measurement platform, the method comprising: receiving, by the measurement platform, the measurement platform configured to measure performance of an advertisement, the measurement platform comprising a demand-side platform (DSP), the measurement platform further comprising a profile storage configured to store an end user profile, the end user profile comprising a set of features associated with the end user, the measurement platform further comprising a control group storage configured to store an identifier of a control user (“control user identifier”), the measurement platform further comprising a control group builder operably connected to the data platform, the control group builder configured to update the control group with similar statistical properties to an exposed group of end users (“exposed users”) that have seen the winning advertisement, an advertisement display notification notifying the measurement platform that a device under control of the end user (“user device”) has displayed to the end user a winning advertisement from a client DSP, the client DSP comprising a DSP of a client of the measurement platform, the winning advertisement having won an auction run by a supply-side platform (SSP) operably connected to the DSP, the advertisement display notification comprising an identifier of the end user; storing, by the measurement platform, the identifier of the exposed end user (“exposed user identifier”) in the exposed group; updating, by the exposed group storage, the exposed group; retrieving, by the control group builder, a selected portion of the exposed user identifiers; retrieving, by the control group builder, a selected portion of the control user identifiers; retrieving, by the control group builder, a selected portion of the end user profiles comprised in the profile storage; encoding, by the control group builder, using one-hot-encoding, an end user profile into a binary feature vector, wherein at least one element of the binary feature vector equals 0 or 1; sorting, by the control group builder, the binary feature vector into one of a group comprising exposed binary feature vectors (“an exposed binary feature vector group”), a group comprising control binary feature vectors (“a control binary feature vector group”), and a control pool comprising all available binary feature vectors that are not comprised in one or more of the exposed binary feature vector group and the control binary feature vector group; determining, by the control group builder, using the exposed binary feature vector group and using the control binary feature vector group, an actual index vector, the actual index vector comprising a measure of a difference between the binary feature vectors corresponding to the exposed users (“exposed binary feature vectors”) and the binary feature vectors corresponding to the control users (“control binary feature vectors”), using an equation (1):

$$actual\_index {\_vector}_{i} = ln ( \frac{( {expCount}_{i}^{⋆} numConBFVectors )}{( {conCount}_{{i}^{⋆}} numExpBFVectors )} ) , \qquad ( 1 )$$

wherein:
expCountᵢ=a count of 1's comprised in an ith element of the exposed binary feature vector;
conCountᵢ=a count of 1's comprised in respective ith element of the control binary feature vectors;
numConBFVectors=number of binary feature vectors comprised in the control group; and
numExpBFVectors=number of binary feature vectors comprised in the exposed group;
   determining, by the control group builder, a dot product between the actual index vector and a binary feature vector comprised in the control pool; storing, by the control group builder, the dot product in the control group storage; selecting, by the control group builder, a best control binary feature vector having a maximum value of the dot product; transferring, by the control group builder, the best control binary feature vector from the control pool to the control group; storing, by the control group builder, the identifier of the new control user (“control user identifier”) in the control group storage; determining, by the measurement platform, that a size of the control group comprises at least a required control group size; receiving, by the measurement platform, an advertisement request copy from the SSP; sending, by the measurement platform, to the SSP a measurement platform bid that wins the auction, the measurement platform bid comprising an amount of money the measurement platform offers to pay for the opportunity to display on the user device a survey configured to measure on behalf of the client DSP performance of the winning advertisement the measurement platform bid further comprising the survey; sending, by the measurement platform, the survey to the end user; receiving, by the measurement platform, a response to the survey from the end user; determining, by the measurement platform, a metric measuring performance of the winning advertisement; and sending, by the measurement platform, the metric to the client DSP.

### BRIEF DESCRIPTION OF THE FIGURES

The figures depict various embodiments for purposes of illustration only. One skilled in the art will readily recognize from the following discussion that alternative embodiments of the structure and methods illustrated herein may be employed without departing from the principles described herein.

FIG. 1 is a drawing of a measurement platform configured to receive an advertisement display notification, to send a survey for the purpose of advertisement performance measurement, and to receive a response to the survey.

FIG. 2 is a drawing of an environment comprising the measurement platform, an end user, a client demand-side platform (DSP), and an advertiser.

FIG. 3 is a drawing of an environment in which a measurement platform provides a performance measurement service for a client DSP.

FIG. 4 is a flow chart of a method for measuring effectiveness of an advertisement, using a measurement platform.

FIG. 5 is a flow chart of a method for measuring effectiveness of an advertisement, using a measurement platform.

FIG. 6 is a flow chart of a method for measuring effectiveness of an advertisement, using a measurement platform.

FIGS. 7A-7B show the typical placing of a winning advertisement in a reserved advertising space on a used device, and an example of a survey that may be displayed in the reserved advertising space.

FIG. 8 is a bar graph representing graphically the experimental results of the experiment measuring performance of embodiments of the invention relative to the three prior art processes and demonstrating superior performance of embodiments of the invention.

### DETAILED DESCRIPTION

Embodiments of the invention provide an automated system comprising a measurement platform, the measurement platform configured to measure performance of an advertisement. For example, the advertisement comprises one or more of an online advertisement and a non-online advertisement. Preferably, but not necessarily, the advertisement comprises an online advertisement.

A demand-side platform (DSP) comprises a software platform that enables an advertiser to purchase digital advertising space programmatically and in real time. DSPs streamline the advertisement buying process by allowing the advertiser to use a centralized platform run by the advertiser to manage advertisements. The measurement platform comprises a DSP, the measurement platform configured to send a survey usable to measure performance of the advertisement. The measurement platform is further configured to do one or more of receive an advertisement display notification, send a survey for the purpose of advertisement performance measurement, and receive a response to the survey.

A client DSP comprises a DSP operated by a client of the measurement platform, the client DSP running an advertisement and seeking to have the performance of the advertisement measured by the measurement platform. Other than the fact that the client DSP is operated by the client of the measurement platform, the client DSP lacks any further differences from the other DSPs. Before the advertisement starts, the advertiser commissions the advertisement with the client DSP. For example, the measurement platform is configured to send a survey usable to measure performance of an online advertisement being run by the client DSP. Using the survey, the measurement platform is further configured to measure the performance of the advertisement running on the client DSP.

Following is a succinct overview of embodiments of the invention: An advertiser approaches the client DSP to commission the client DSP to run an advertisement on behalf of the advertiser. For example, a well-known automobile manufacturer such as Bayerische Motoren Werke AG, (commonly known as “BMW”) of Munich, Germany (www.bmw.com) wishes to send one million advertisements to mobile devices in one month.

The advertiser wants to know that the DSP will send the advertisements to people where the advertisement will have the most effect.

The measurement platform is configured to measure performance of the advertisement to the advertiser. The client DSP pays the measurement platform for its services measuring the performance of the advertisement.

The client DSP learns that a device under control of an end user (the “user device”) has displayed a winning advertisement in an advertising auction among DSPs bidding to have their respective candidate advertisements become the winning advertisement. The user device preferably comprises a mobile user device. Alternatively, or additionally, the user device comprises a non-mobile device. Alternatively, or additionally, the user device comprises a device of any type under the control of the end user and configured to display the winning advertisement. For example, the user device comprises one or more of a cellular phone, a mobile phone, a smartphone, a tablet, a laptop computer, a notebook computer, a desktop computer, and another device. The end user uses one or more of an application (“app”) on the user device and a web page that the user browses.

For simplicity, we address the case where the end user is using the user device, as operation of embodiments of the invention is not significantly changed in case the end user is instead browsing the web page.

Then the client DSP notifies the measurement platform that the user device has displayed a winning advertisement to the end user. Preferably, but not necessarily, the client DSP both learns of the display of the winning advertisement and notifies the measurement platform of the display by placing in the winning advertisement a tracking pixel configured to trigger a mobile device under control of an end user (the “user device”), upon display of the winning advertisement by the user device to the end user, to send to the measurement platform an advertisement display notification. Alternatively, or additionally, the client DSP may use any other method other than the placement of the tracking pixel in the winning advertisement to learn of the display to the end user of the winning advertisement to the end user. For example, a supply-side platform (SSP) can notify the client DSP that the advertisement has been displayed. A supply-side platform (SSP) comprises a technology platform that enables publishers to manage and sell their digital advertising inventory programmatically. Alternatively or additionally, the client DSP may use any other method other than the placement of the tracking pixel in the winning advertisement to notify the measurement platform that the advertisement has been shown to a particular end user. For example, the client DSP can directly send the advertisement display notification to the measurement platform.

The SSP runs an auction, accepting bids from the DSPs, the client DSP, and the measurement platform. The SSP selects as a winning advertisement in the auction a candidate advertisement comprising a highest bid.

Alternatively, or additionally, instead of running the auction, the SSP may instead run a waterfall system where the SSP sequentially offers the advertisement request to a plurality of DSPs in a predefined order at a predetermined price.

If the client DSP's bid wins the auction that the SSP runs, the SSP sends to the end user a winning advertisement comprising the tracking pixel. The tracking pixel triggers the user device to send an advertisement display notification to the measurement platform. The measurement platform receives the advertisement display notification from the user device. Alternatively, or additionally, the measurement platform receives the advertisement display notification directly from the client DSP. The advertisement display notification comprises an identifier of the end user.

The identifier comprises one or more of a device identifier of a user device of the end user, a unified identifier created by an identifier provider and configured to identify the end user, and another identifier configured to identify the end user.

For example, the unified identifier comprises one or more of a Trade Desk Unified ID 2.0 identifier provided by The Trade Desk of Ventura, California (www.thetradedesk.com), and a LiveRamp ID provided by LiveRamp of San Francisco, California (www.liveramp.com).

Using the advertisement display notification that the measurement platform receives, the measurement platform updates an exposed group of exposed users, that is, of end users that have seen the winning advertisement (“exposed users”). Updating the exposed group comprises creating the exposed group if it does not already exist. Updating the exposed group comprises storing an identifier of an exposed user. The measurement platform, on receipt of the advertisement display notification, stores the identifier of the end user in the exposed group.

As discussed in more detail below, the measurement platform also updates, with an identifier of a new control user, a control group comprising end users that have similar statistical properties to the exposed group except that the control group members (“control users”) have not seen the winning advertisement. Updating the control group comprises creating the control group if it does not already exist. By similar statistical properties, we mean that across all known features of the end users, as contained in the respective end user profiles of the respective end users, the distribution of values is the same. For example, there would be the same proportion in each group by gender, age, phone operating system, and the like. Updating the control group comprises storing an identifier of a control user.

The measurement platform then sends a survey to one or more of the exposed user and the control user. For example, when the measurement platform receives a measurement platform advertisement request copy comprising an identifier of the end user, the measurement platform sends the survey to the end user associated with the identifier. Preferably, but not necessarily, the end user comprises one or more of a control user and an exposed user. Preferably, but not necessarily, upon receiving the advertisement display notification, the measurement platform sends the survey to the end user by sending to a supply-side platform (SSP) a measurement platform bid that wins the auction, the measurement platform bid comprising an amount of money the measurement platform offers to pay for the opportunity to display on the user device a survey configured to measure performance of the advertisement, the measurement platform bid further comprising the survey. Alternatively, or additionally, the DSP may be directly connected to the user device. In such embodiments, the end user sends the advertisement display notification directly to the DSP.

Preferably, but not necessarily, the survey comprises an online survey. The survey is configured to measure an impact of the advertisement. For example, for an automotive advertisement for BMW, the survey may comprise the question: “Would you consider purchasing a new BMW car in the next six months?” As mentioned above, the measurement platform bid comprises an amount of money the measurement platform offers to pay for the opportunity to display on the user device a survey configured to measure performance of the advertisement, the measurement platform bid further comprising the survey. Preferably, although not necessarily, the measurement platform bid does not comprise a candidate advertisement.

The measurement platform is further configured to receive a survey response from the end user after the end user completes the survey and sends the survey to the measurement platform.

The measurement platform is further configured, using the survey, to measure the performance of the advertisement running on the client DSP. For example, the measurement platform measures the performance of the advertisement by comparing survey responses of end users that have seen a winning advertisement from a DSP that has won an advertising auction to survey responses of control group members that have not seen the winning advertisement.

For example, the measurement platform accumulates several hundred survey responses. The measurement platform determines a difference between exposed group responses and control group responses, wherein the response difference measures performance of the advertisement.

For example, if the control group responds “yes” (to the question about considering purchasing a new BMW car in the next six months) in 5% of cases and the exposed group responds “yes” in 10% of cases, then the measurement platform attributes the difference to the advertisement. This result implies that the client DSP has advertised to an effective audience and has carried out an effective advertisement. The measurement platform sends the response difference to the client DSP.

The client DSP presents the response difference to the advertiser, who concludes the advertisement has been successful.

An advertisement spot comprises advertising space reserved for the winning advertisement on the user device when the user device loads a winning advertisement as part of the app. After the user device loads the winning advertisement, the end user sends an advertisement display notification to the measurement platform. SSPs facilitate the automated sale of advertising space to advertisers through real-time auctions, optimizing revenue for publishers by connecting their inventory with demand from advertisers and advertising networks. The advertisement request comprises data regarding one or more of the end user, the user device, and other information (“end user data”). Preferably, but not necessarily, a plurality of DSPs are operably connected to the SSP. Upon receiving the advertisement request, the SSP forwards an advertisement request copy, the advertisement request copy comprising a copy of the advertisement request, to a connected DSP. The connected DSP may comprise the client DSP, in which case for convenience we call the advertisement request copy a client DSP advertisement request copy. The advertisement request copy comprises the data comprised in the advertisement request regarding one or more of the end user, the user device, and other information. Preferably, but not necessarily, the SSP forwards the advertisement request copy to all the DSPs including the client DSP, in which case, as mentioned above, for convenience we call the advertisement request copy a client DSP advertisement request copy. The SSP offers at least one of the DSPs the opportunity to bid in the real-time auction held by the SSP. Preferably, but not necessarily, the SSP offers each of the DSPs including the client DSP the opportunity to bid in the real-time auction held by the SSP. The DSPs including the client DSP then place DSP bids with the SSP, the DSP bid comprising an amount of money the bidding DSP offers to pay for the opportunity to display the winning advertisement on the user device to the end user. The DSP bid from the DSPs including the client DSP further comprises a candidate advertisement for the SSP to forward to the user device if the bid of the respective DSP wins the auction, thereby transforming the candidate advertisement into the winning advertisement. The measurement platform also places the measurement platform bid with the SSP.

Preferably, but not necessarily, the SSP runs the auction in milliseconds. Preferably, but not necessarily, the SSP runs an auction for each advertisement request that the SSP receives. Most preferably, but not necessarily, the SSP runs the auction for each advertisement request that the SSP receives in milliseconds. The SSP selects as a winning advertisement the candidate advertisement comprised in a winning bid that the SSP determines is the highest bid in the auction. The SSP sells to the winning DSP the right to display the winning DSP's advertisement on the user device. The SSP then forwards the winning advertisement to the user device for display in the advertisement spot. If the measurement platform places a winning bid, the winning advertisement comprises the survey. In that case, after the end user receives the survey, the user device displays the survey to the end user.

The survey comprises a request to the end user to send the survey response to the measurement platform after completing the survey. For example, the survey comprises a request to the end user to click a “submit” button to send the survey response. When the user clicks the “submit” button, the user thereby triggers a hypertext transfer protocol (HTTP) request embedded within the survey, the HTTP request configured to send the survey answers to the measurement platform. The measurement platform then determines the performance of the advertisement from the survey responses.

For example, the measurement platform is further configured to measure the performance of an online advertisement that a client DSP is running on a client system. The client DSP runs an online advertisement to place a winning advertisement in front of a desired audience. After viewing the winning advertisement, the audience becomes an exposed group, that is, the group of end users that has seen the winning advertisement. For example, the client DSP places the winning advertisement itself. For example, the client DSP places the winning advertisement using a direct connection between the client DSP and the user device. Alternatively, or additionally, the client DSP places the winning advertisement using a connection made via a server-side platform (SSP).

The client DSP places in the winning advertisement a tracking pixel configured to trigger the user device, upon display of the winning advertisement by the user device to the end user, to send to the measurement platform an advertisement display notification. The advertisement display notification comprises an identifier of the end user. The user device is only triggered to send the advertisement display notification if the client DSP wins the auction, meaning that the candidate advertisement becomes the winning advertisement. The advertisement display notification comprises an identifier of the end user.

The measurement platform is configured to update an exposed group of end users that have seen the winning advertisement (“exposed users”). The measurement platform is further configured to receive the advertisement display notification comprising the identifier of the exposed user (“exposed user identifier”). The measurement platform, on receipt of the advertisement display notification, stores the exposed user identifier in the exposed group. Preferably, but not necessarily, the measurement platform is configured to update the exposed user group after receiving a new exposed user identifier. More preferably, but not necessarily, the measurement platform is further configured to update the exposed user group in real-time after receiving a new exposed user identifier. Most preferably, but not necessarily, the measurement platform periodically updates the exposed user group after receiving the new exposed user identifier. For example, the updating occurs every 24 hours. For example, the updating occurs every hour.

The measurement platform also periodically updates the control group with a new control user identifier. The measurement platform determines a new control update size equal to a number of exposed users added to the exposed user group since a last update. The measurement platform then selects a number of new control users equal to the control update number. The measurement platform then adds the new control users to the control group.

An end user profile comprises a set of features associated with the end user. The feature comprises one or more of a measurable property of the end user and a measurable characteristic of the end user. For example, the feature comprises one or more of end user demographic Information, end user behavioral information, end user location, end user interests and preferences, user device information, end user browsing history, end user's advertisement engagement, end user's referral source, end user's operating system, and another relevant criterion. For example, the demographic information comprises one or more of age, gender, marital status, location, income level, and other demographic factors. For example, the behavioral information comprises one or more of online behavioral information and offline behavioral information. For example, the online behavioral information comprises one or more of a web page visited by the end user, content with which the end user engages, a product the end user views, the end user's interaction pattern, and other behavioral information providing insights into the user's online behavior. For example, the interaction comprises one or more of an interaction with a mobile app, an interaction with a website, an interaction with another end user, and an interaction with a winning advertisement. For example, the interaction with the mobile app comprises one or more of a screen that the end user views, an action that the end user performs, and another interaction. For example, the interaction with the website comprises one or more of a page that the end user views, an action that the end user performs on the website, and another interaction with the website. For example, the interests and preferences comprise one or more of the end user's interests, the end user's preferences, and the end user's affinities. Preferably, but not necessarily, the one or more of the end user's interests, the end user's preferences, and the end user's affinities are based on their online activities. For example, the user device Information comprises one or more of a device type, a device operating system, a device screen size, a device storage capacity, a device memory capacity, a device brand, a device application requesting the winning advertisement. For example, the browsing history comprises one or more of information about the end user's past interactions online and the end user's browsing history online. For example, the browsing history comprises one or more of a website that the end user visits, a web page that the end user views, a product that the end user views, and a search that the end user conducts. The end user's advertisement engagement comprises engagement data related to the user's response to previous winning advertisements. For example, the engagement data comprises one or more of a click by the end user, a date of the click by the end user, a time of the click by the end user, a conversion of the end user, a date of the conversion of the end user, a time of the conversion of the end user, an interaction of the end user with the winning advertisement content, a date of the interaction of the end user with the winning advertisement content, and a time of the interaction of the end user with the winning advertisement content. The end user's referral source comprises a source through which the end user arrives to the winning advertisement. For example, the end user's referral source comprises one or more of a search engine, a social media resource, a referral link, a website, a web page, and another referral source. Some end users make a direct entry to the advertisement without a referral source.

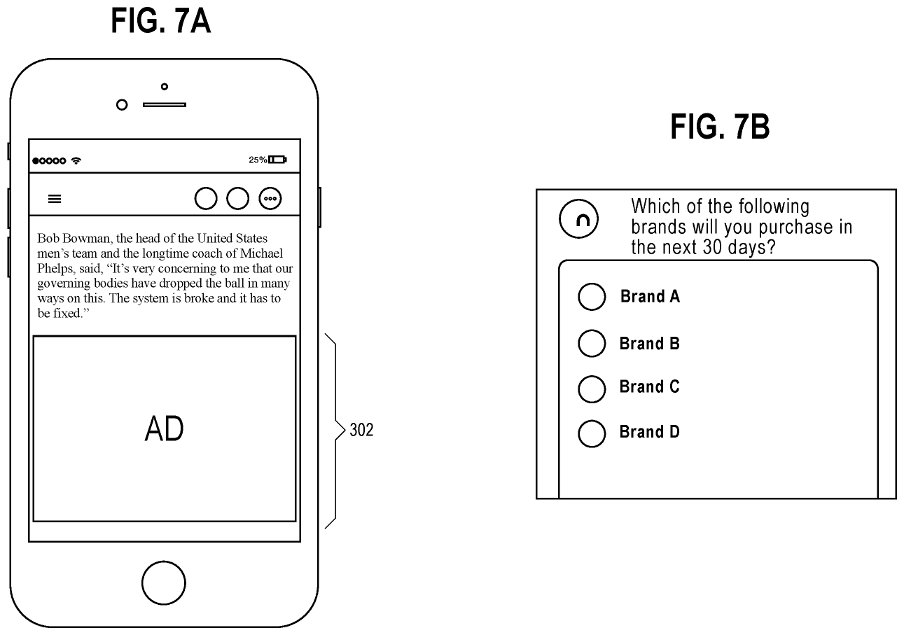

Preferably, but not necessarily, the end user profile comprises a set of feature-value pairs that stores all known data regarding the end user. For example, as discussed in FIG. 7, city=London, operating_system=iOS, additionally for example gender=female, and the like.

For example, the measurement platform further comprises a profile storage of many end users from which the measurement platform selects the control group. Preferably, but not necessarily, the profile storage comprises sets of end user features. For example, regarding a particular end user, the profile storage comprises one or more of demographic data, user device data, information on the end user's historical app usage, information on the end user's historical website usage, and other data.

The measurement platform further comprises a control group builder configured to update, with an identifier of a new control user, a control group with similar statistical properties to the exposed group. The control group builder is configured to update the control group using one or more of a continuous process and a process following a predetermined regular schedule.

Preferably, but not necessarily, the measurement platform is further configured to update the exposed group in real time. Preferably, but not necessarily, the measurement platform is further configured to update the control group in real time.

The control group builder uses a feature stored in the profile storage to determine similarity of the control group and the exposed group. Using the control group feature and the exposed group feature to determine the similarity of the control group and the exposed group, the control group builder determines an actual index vector, which is defined as a difference between the end user profiles corresponding to the exposed users (“exposed user profiles”) and the end user profiles corresponding to the control users (“control user profiles”). Preferably, but not necessarily, the actual index vector expresses differences across all features comprised in the end user profiles. An index of 0 for a particular feature of interest indicates that this feature is equally represented in the control group and the exposed group. An index greater than 0 indicates that the feature of interest is under-represented in the control group relative to the exposed group. An index less than 0 indicates that the feature of interest is over-represented in the control group relative to the exposed group.

The control group builder selects from the profile storage an end user profile that minimizes a difference between the actual index vector and an ideal index vector. The ideal index vector comprises a vector having a number of elements equal to a number of elements of the actual index vector, wherein each element of the ideal index vector equals 0. For each element of the ideal index vector, a ratio of a frequency of occurrences in control and exposed of a feature value represented by the element (for example, the city is London) is equal to 1. The ideal index vector contains a natural logarithm of this value, i.e., In (1)=0.

The ideal index vector represents an ideal case: in which every feature is equally represented in the control group and the exposed group, thus every element of the ideal index vector is 0. Accordingly, the difference between the actual index vector and the ideal index vector is a measure of a difference between the exposed user profiles and the control user profiles. That is, the control group builder selects from the profile storage the control user profile that has similar statistical properties to the exposed user profile.

An advantage of the novel use of a logarithm function in the actual index vector ensures that in cases where there are no exposed users with a particular feature value (for example an advertisement may be geographically excluded from particular states for legal reasons), then embodiments of the invention ensure that there will be no control users with that particular feature value.

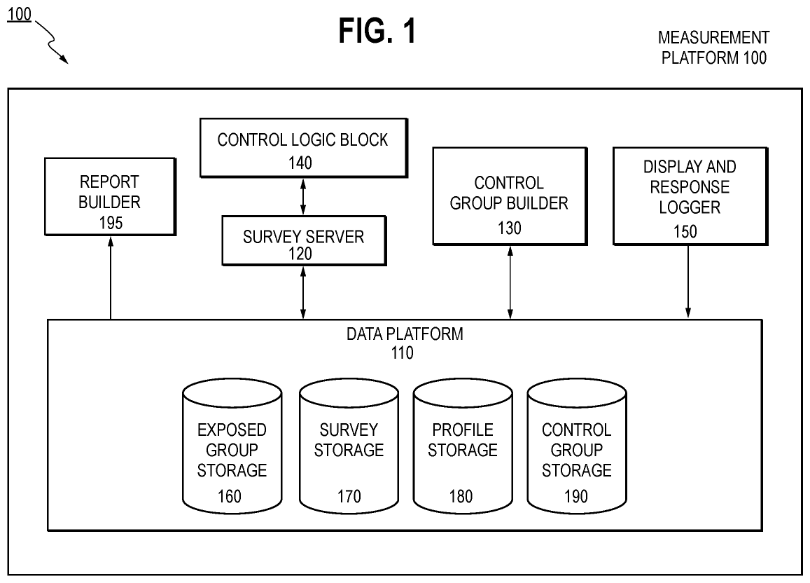

FIG. 1 is a drawing of a measurement platform 100. The measurement platform 100 comprises a demand-side platform (DSP) 100 configured to do one or more of receive an advertisement display notification, send a survey for the purpose of advertisement performance measurement, and receive a response to the survey.

The measurement platform 100 is configured to receive an advertisement display notification (not shown in FIG. 1) from an end user (not shown in FIG. 1). An advertisement display notification comprises an identifier of the end user who has seen a winning advertisement (not shown in FIG. 1) and thus is in a group of end users exposed to the winning advertisement (“exposed group”).

The measurement platform 100 comprises functionality of a DSP usable to send the survey. The measurement platform 100 is further configured to receive a response to the survey from one or more of the control user and the exposed user. Preferably, but not necessarily, the measurement platform 100 is configured to receive the survey response from both the control user and from the exposed user. The measurement platform 100 comprises a data platform 110 configured to store data usable by the measurement platform 100, a survey server 120 operably connected to the data platform 110, the survey server 120 configured to request a survey (not shown in FIG. 1) from the data platform 110, a control group builder 130 operably connected to the data platform 110, the control group builder 130 configured to update, with an identifier of a new control user, a control group with similar statistical properties to an exposed group that has seen the winning advertisement, and a control logic block 140 operably connected to the survey server 120, the control logic block 140 configured to receive the survey from the survey server 120. Updating the control group comprises creating the control group if it does not already exist. The control group builder 130 is configured to update the control group using one or more of a continuous process and a process following a predetermined regular schedule.

The control logic block 140 is further configured to send the survey (not shown in FIG. 1) to the end user. Preferably, but not necessarily, the control logic block 140 is further configured, upon receiving the advertisement request copy from the SSP, to send the survey to the end user by sending to a supply-side platform (SSP) a measurement platform bid that wins the auction, the measurement platform bid comprising an amount of money the measurement platform 100 offers to pay for the opportunity to display on the user device a survey configured to measure performance of the advertisement, the measurement platform bid further comprising the survey. Preferably, but not necessarily, the end user comprises one or more of a control user and an exposed user. Preferably, but not necessarily, the control logic block 140 is configured to send the survey to both the control user and the exposed user. Most preferably, but not necessarily, the control logic block 140 is configured to send the survey to all available control users and the control logic block 140 is further configured to send the survey to all available exposed users. For example, an unavailable user is unavailable for a reason comprising one or more of not visiting a web page that triggers an advertisement request, not visiting a mobile device app that triggers the advertisement request, not turning the user device on, obtaining a new end user identifier, or another unavailability reason.

The measurement platform 100 further comprises a display and response logger 150 operably connected to the data platform 110, the display and response logger 150 configured to store data regarding display on the user device of the winning advertisement. The display and response logger 150 is further configured to log a completed end user response to the survey. The display and response logger 150 is further configured to update the exposed group.

The data platform 110 comprises an exposed group storage 160 configured to store the exposed group. The data platform 110 further comprises a survey storage 170 configured to store surveys to be sent to the end users when the survey storage receives a survey request from the survey server 120, the survey storage 170 further configured to send the requested survey to the survey server 120, a profile storage 180 configured to store an end user profile, and a control group storage 190 configured to store an identifier of a control user. Updating the exposed group comprises creating the exposed group if it does not already exist.

The exposed group storage 160 is further configured to receive the advertisement display notification comprising the exposed user identifier. The exposed group storage, on receipt of the advertisement display notification, stores the exposed user identifier in the exposed group. More preferably, but not necessarily, the exposed group storage 160 is further configured to update the exposed group after receiving a new exposed user identifier. Most preferably, but not necessarily, the exposed group storage 160 is further configured to update the exposed group in real-time after receiving a new exposed user identifier. Preferably, but not necessarily, the exposed group storage 160 periodically updates the exposed group after receiving the new exposed user identifier. For example, the updating occurs every 24 hours. For example, the updating occurs every hour.

An end user profile comprises a set of features associated with the end user. Preferably, but not necessarily, the profile storage 180 is configured to store profiles of all exposed users. Preferably, but not necessarily, the profile storage 180 is further configured to store the end user profiles of all control users. Preferably, but not necessarily, the profile storage 180 is further configured to store a plurality of historically gathered end user profiles.

The control group builder 130 periodically updates the control group. The exposed group storage 160 determines a new control update size equal to a number of new exposed users that the exposed group storage 160 added to the exposed user group since a last update. The control group builder 130 requests and then receives one or more of needed exposed user identifiers and the control update size from the exposed group storage 160. The control group builder 130 also requests and then receives needed end user profiles from the profile storage 180. The control group builder 130 then selects a number of new control group members equal to the control update size. The control group builder 130 then adds the new control group members to the control group. Most preferably, but not necessarily, the control group builder 130 is further configured to update the control group in real-time.

For example, the control group builder 130 selects the control group from the profile storage 180. Preferably, but not necessarily, the profile storage 180 comprises sets of end user features. For example, regarding a particular end user, the profile storage 180 comprises one or more of demographic data, user device data, information on the end user's historical app usage, information on the end user's historical website usage, and other data.

The display and response logger 150 receives an identifier of the end user that has seen the winning advertisement. The display and response logger 150 stores the exposed user identifier in the exposed group storage 160. Preferably, but not necessarily, the display and response logger 150 further comprises a timestamper configured to record one or more of a date when the exposed group storage 160 receives the exposed user identifier and a time when the exposed group storage 160 receives the exposed user identifier. Most preferably, but not necessarily, the display and response logger 150 further comprises a timestamper configured to record both the date when the exposed group storage 160 receives the exposed user identifier and the time when the exposed group storage 160 receives the exposed user identifier.

Via the survey server 120 and the control logic block 140, the survey storage 170 sends the survey to the end user. The display and response logger 150 receives a response completed by the end user to the survey. The display and response logger 150 also stores the survey response in the profile storage 180.

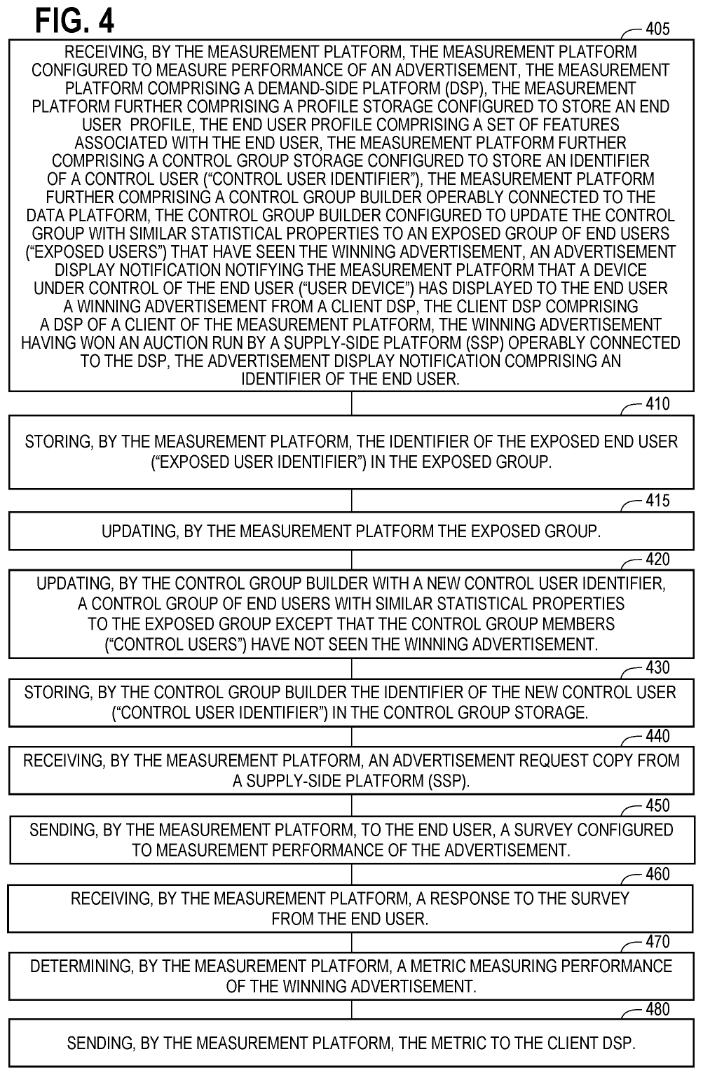

The control group builder 130 retrieves end user profiles comprised in the profile storage 180, then uses the retrieved end user profiles to update the control group identifiers which it then sends to the control group storage 190 for storage. Updating the control group comprises creating the control group if it does not already exist. Typically, but not necessarily, the control group builder 130 retrieves a selected portion of the end user profiles comprised in the profile storage 180. For example, the control group builder randomly selects the selected portion of the end user profiles. Alternatively, or additionally, the control group builder 130 retrieves all the end user profiles comprised in the profile storage 180. Typically, but not necessarily, the end user profiles in the profile storage 180 comprises a numerically much larger group than the end user profiles of the exposed group members comprised in the exposed group storage 160. Further details regarding the operation of the control group builder 130 are provided below in FIGS. 4-6 and the accompanying text.

The measurement platform 100 further comprises a report builder 195 operably connected to the data platform 110, the report builder 195 configured to determine a metric measuring performance of the advertisement of the client DSP. Preferably, but not necessarily, the report builder 195 uses the completed survey responses to determine the metric. Preferably, but not necessarily, the report builder 195 is further configured to send the metric to the client DSP.

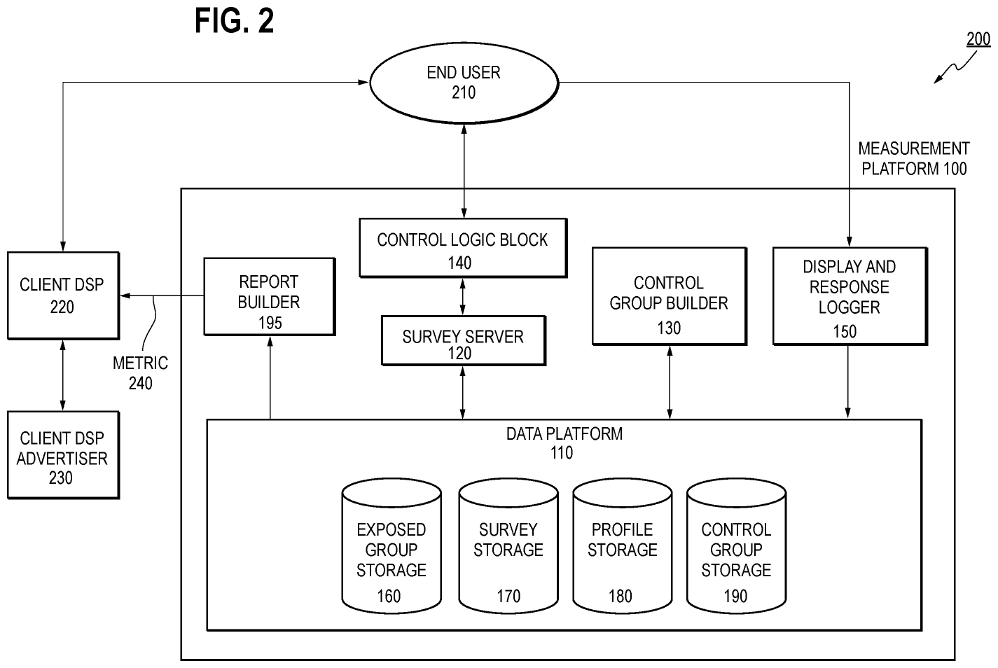

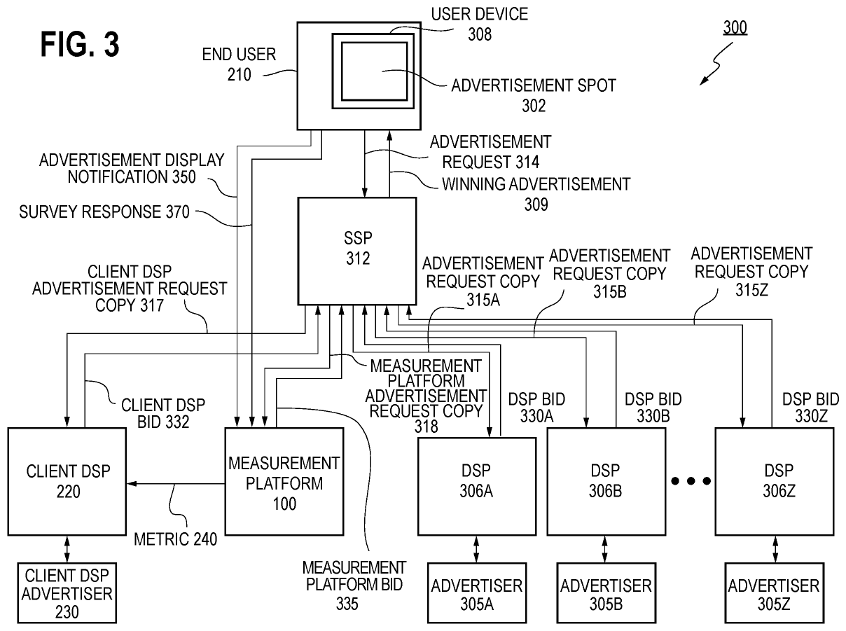

FIG. 2 is a drawing of an environment 200 comprising the measurement platform 100, an end user 210, a client demand-side platform (DSP) 220, and a client DSP advertiser 230. The end user 210 comprises a user doing one or more of using an application (“app”) on a mobile device and browsing a web page. For simplicity, we address the case where the end user is using the user device, as operation of embodiments of the invention is not significantly changed in case the end user is instead browsing the web page. The end user 210 can use any device configured to allow the end user 210 to view a winning advertisement. The end user 210 is operably connected to the measurement platform 100. The client DSP 220 comprises a DSP operated by a client of the measurement platform 100, the client DSP 220 running an advertisement (not shown in figures), the client of the measurement platform seeking to have performance of the advertisement measured by the measurement platform 100. The client DSP 220, which is by definition operated by the client, does not differ in functionality from other DSPs (not shown in FIG. 2; items 306A, 306B . . . 306Z in FIG. 3). For convenience of explanation, we call it the “client DSP 220.” The client DSP 220 comprises one or more of an offline client DSP 220 and an online client DSP 220. The client DSP 220 is shown as operably connected to the end user 210. As shown in more detail in FIG. 3, in fact the end user 210 is operably connected to the SSP (not shown in FIG. 2; item 312 in FIG. 3), and the SSP is in turn operably connected to the client DSP 220. The client DSP advertiser 230 is operably connected to the client DSP 220. Before an advertisement starts, the client DSP advertiser 230 commissions the advertisement with the client DSP 220. For example, the client DSP advertiser 230 requires 1 million sends of a specified advertisement over the next 1 month. Once the advertisement starts, the advertiser will only receive feedback about the results. The client DSP is configured to send the winning advertisement to the end user 210 via the user device. The user device comprises an app which in turn comprises an advertisement spot (not shown in FIG. 2), that is, a space on the user device configured to receive a winning advertisement from the client DSP 220. Typically, but not necessarily, the user device comprises a plurality of advertisement spots configured to receive a winning advertisement from the client DSP 220. The user device receives the winning advertisement. The user device then places the winning advertisement in the advertisement spot.

The measurement platform 100 again comprises the data platform 110, the survey server 120, the control group builder 130, the control logic block 140, and the display and response logger 150. The data platform 110 again comprises the exposed group storage 160, the survey storage 170, the profile storage 180, and the control group storage 190. The exposed group storage 160 again receives the exposed user identifier of the end user 210 that has seen the winning advertisement from the client DSP 220. The exposed group storage 160 stores the exposed user identifier. The survey storage 170 again stores the surveys (not shown) to be sent to the end user 210 when the survey server 120 sends a survey request. The survey storage 170 also again sends the requested survey to the survey server 120. The profile storage 180 again stores the end user profile. The control group builder 130 sends the control user identifier to the control group storage 190. The control group storage 190 again stores the control user identifier.

The display and response logger 150 again receives an identifier of the end user that has seen the winning advertisement. The display and response logger 150 again stores the exposed user identifier in the exposed group storage 160. Preferably, but not necessarily, the display and response logger 150 further comprises a timestamper again configured to record one or more of a date when the exposed group storage 160 receives the exposed user identifier and a time when the exposed group storage 160 receives the exposed user identifier. Most preferably, but not necessarily, the display and response logger 150 further comprises a timestamper again configured to record both the date when the exposed group storage 160 receives the exposed user identifier and the time when the exposed group storage 160 receives the exposed user identifier.

Via the survey server 120 and the control logic block 140, the survey storage 170 again sends the survey to the end user. The display and response logger 150 again receives a response completed by the end user to the survey. The display and response logger 150 again also stores the survey responses in the profile storage 180. The profile storage 180 is again configured to store the historically gathered end user profiles.

Next the control logic block 140 receives an advertisement request from an end user 210. When the control logic block 140 detects the advertisement request from the end user 210 with an end user identifier in one or more of the control group storage 190 and the exposed group storage 160, the control logic block 140 requests a survey from the survey server 120. The survey server 120 retrieves the survey from the survey storage 170. The survey server 120 then sends the survey to the control logic block 140. The control logic block 140 sends the survey to the end user 210. The control logic block 140 is configured to send the survey to one or more of a control user and an exposed user. The control logic block 140 is configured to send the survey to both the control user and the exposed user. After the end user 210 completes the survey, creating a survey response, the end user 210 sends the survey response (not shown in FIG. 2; item 370 in FIG. 3) to the display and response logger 150. Alternatively, the survey comprises a request to the end user 210 to send the survey response to the display and response logger 150. For example, the survey comprises a request to the end user to click a “submit” button to send the survey response. To send the survey response, the measurement platform 100 sends HyperText Markup Language (HTML) code within the survey to the measurement platform 100. The display and response logger 150 stores the completed survey response in the profile storage 180.

The control group builder 130 again periodically updates the control group. The exposed group storage 160 again determines a new control update size equal to a number of new exposed users that the exposed group storage 160 added to the exposed user group since a last update. The control group builder 130 again requests and then receives one or more of needed exposed user identifiers and the control update size from the exposed group storage 160. The control group builder 130 also again requests and then receives needed end user profiles from the profile storage 180. The control group builder 130 again then selects a number of new control group members equal to the control update size. The control group builder 130 again then adds the new control group members to the control group. Most preferably, but not necessarily, the control group builder 130 is further configured to update the control group in real-time.

Further details regarding the operation of the control group builder 130 are provided below in FIGS. 4-6, and the accompanying text.

The measurement platform 100 again further comprises the report builder 195 operably connected to the data platform 110, the report builder 195 also operably connected to the client DSP 220, the report builder 195 configured to determine a metric 240 measuring performance of the advertisement of the client DSP 220. Preferably, but not necessarily, the report builder 195 is further configured to send the metric 240 to the client DSP 220.

Preferably, but not necessarily, the metric 240 comprises one or more of a response ratio, a response difference, and an uplift percentage. The response ratio comprises a ratio of a percentage of exposed users that respond positively to the advertisement to a percentage of control users that respond positively to the advertisement. The response difference comprises a difference of the percentage of exposed users responding positively to the percentage of control users responding positively. The uplift percentage comprises 100 times (the response ratio minus one).

For example, a survey requires the end user to answer either yes or no regarding the advertisement's performance (whether they will buy the product or service). In the control group, out of 100 responses, 10 control users answer “yes” and 90 answer “no,” whereas in the exposed group, 20 answer “yes” and 80 answer “no.” In this example, the response difference=20%−10%=10%. The response ratio=20%/10%=2. The uplift percentage=100*(20%/10%−1)=100%.

FIG. 3 is a drawing of an environment 300 in which the measurement platform 100 provides a performance measurement service for the client DSP 220. The environment 300 comprises the measurement platform 100, the end user 210, the client DSP 220, and a plurality of advertisers 305A, 305B . . . 305Z, each running an advertisement. Each of the plurality of advertisers 305A, 305B . . . 305Z is operably connected to a respective DSP 306A, 306B . . . 306Z. For example, a first advertiser 305A is operably connected to a first DSP 306A. A client DSP advertiser 230 is operably connected to the client DSP 220. Other than being operably connected to the client DSP 220 rather than to a DSP 306A, 306B . . . 306Z, the client DSP advertiser 230 is functionally indistinguishable from the other advertisers 305A, 305B . . . 305Z. The environment 300 further comprises the measurement platform 100, the end user 210, and the client DSP 220. The end user 210 controls a user device 308. The user device 308 preferably comprises a mobile user device 308. Alternatively, or additionally, the user device 308 comprises a non-mobile user device 308. Alternatively, or additionally, the user device 308 comprises a user device 308 of any type under control of the end user 210 and configured to display a winning advertisement 309 that wins in an advertising auction. For example, the user device 308 comprises one or more of a cellular phone, a mobile phone, a smartphone, a tablet, a laptop computer, a notebook computer, a desktop computer, and another device. The user device 308 comprises an advertisement spot 302, the advertisement spot 302 usable to display a winning advertisement to the end user 210. Typically, but not necessarily, the advertisement spot 302 comprises one or more of a web page displayed by a computing device, a browser reserved for a winning advertisement, and a selected portion of a mobile device app reserved for a winning advertisement. The environment 300 further comprises a server-side platform (SSP) 312.

The end user 210 views the advertisement spot 302. For example, the end user 210 opens the advertisement spot 302. As the end user views the advertisement spot 302, the advertisement spot 302 automatically sends an advertisement request 314 to the SSP. The SSP 312 holds an auction, sending a copy of the advertisement request 314, known as an advertisement request copy 315A, 315B . . . 315Z, to one or more of the DSPs 306A, 306B . . . 306Z, sending a client DSP advertisement request copy 317 to the Client DSP 220, and sending a measurement platform advertisement request copy 318 to the measurement platform 100. Preferably, but not necessarily, the SSP 312 sends the advertisement request copies 315A, 315B . . . 315Z to each of the DSPs 306A, 306B . . . 306Z. Preferably, but not necessarily, the SSP 312 holds a real-time auction. One or more of the DSPs 306A, 306B . . . 306Z and the client DSP 220 may bid in the auction by sending to the SSP 312 a DSP bid 330A, 330B . . . 330Z. The DSP bid 330A, 330B . . . 330Z comprises an amount of money the bidding DSP offers to pay for the opportunity to display the winning advertisement to the end user. The client DSP 220 places a client DSP bid 332. As with the other DSPs 306A, 306B . . . 306Z, the client DSP bid 332 comprises an amount the client DSP 220 offers in the auction and the client DSP bid 332 also comprises a candidate advertisement that becomes the winning advertisement 180 if the client DSP 220 wins the auction.

Alternatively, or additionally, the measurement platform 100 may bid in the auction by sending a measurement platform bid 335 to the SSP 312. Preferably, but not necessarily, the measurement platform bid 335 comprises one or more of a survey configured to measure performance of the winning advertisement 309 and an amount of money the measurement platform 100 offers to pay for the opportunity to display the survey on the user device 308. The SSP 312 selects a highest bid as a winning bid. The SSP 312 then sends a winning advertisement 309 comprising the candidate advertisement comprised in the winning bid to the advertisement spot 302. If the measurement platform 100 places the measurement platform bid 335 that becomes the winning bid, the winning advertisement comprises the survey. In that case, after the end user 210 receives the survey, the user device 308 displays the survey to the end user 210.

Typically, but not necessarily, the winning advertisement 309 comprises Hyper Text Markup Language (HTML) code configured to render one or more of an image in the winning advertisement 309 and text in the winning advertisement 309. Preferably, but not necessarily, the HTML code renders both the image in the winning advertisement 309 and the text in the winning advertisement 309.

The client DSP 220 places in the winning advertisement 309 a tracking pixel (not shown in FIG. 3) configured to trigger the user device 308, upon display of the winning advertisement 309 by the user device 308 to the end user 220, to send to the measurement platform 100 an advertisement display notification 350. The advertisement display notification 350 comprises an identifier of the end user 210.

The client DSP advertiser 230 that is operably connected to the client DSP 220 does not differ in functionality from the remaining advertisers 305A, 305B . . . 305Z. The client DSP advertiser 230 operates the advertisement and is operably connected to the client DSP 220. Using the user device 308, the end user 210 views an advertisement spot 302. The advertisement spot 302 comprises a space reserved for a winning advertisement 309. The end user 210 then sends to the SSP 312 an advertisement request 314 for the winning advertisement 309 to fill the advertisement spot 302. The advertisement request 314 comprises data regarding one or more of the end user 210, the user device 308, and other information. Preferably, but not necessarily, the advertisement request 314 comprises data regarding one or more of the end user 210, data regarding the user device 308, and other information.

In response to the received advertisement request 314, the SSP 312 then runs an auction in real-time, sending the advertisement request copies 315A, 315B . . . 315Z to the DSPs 306A, 306B . . . 306Z participating in the auction, sending the client DSP advertisement request copy 317 to the client DSP 220, and sending the measurement platform advertisement request copy 318 to the measurement platform 100. Preferably, but not necessarily, the SSP 312 runs an auction for each advertisement request 314 that the SSP 312 receives. The forwarded advertisement request copies 315A, 315B . . . 315Z, the client DSP advertisement request copy 317, and the measurement platform advertisement request copy 318 comprise the data comprised in the advertisement request 314 regarding the one or more of the end user, the user device, and other information.

An advertiser 305A, 305B . . . 305Z is operably connected with a respective DSP 306A, 306B . . . 306Z. Alternatively, or additionally, a client DSP advertiser 230 is operably connected with the client DSP 220. Preferably, but not necessarily, the advertiser 305A, 305B . . . 305Z makes an advertising agreement with the respective DSP 306A, 306B . . . 306Z to which the respective advertiser 305A, 305B . . . 305Z is operably connected. Acting under the operating agreement, the respective advertiser 305A, 305B . . . 305Z sends to one or more of the respective DSP 306A, 306B . . . 306Z and the client advertiser 230 sends to the client DSP 220 a number of candidate advertisements (not shown) for an advertisement. Alternatively, or additionally, the client DSP advertiser 230 makes an advertising agreement with the client DSP 220 to send to the client DSP 220 a number of candidate advertisements (not shown) for an advertisement. Typically, but not necessarily, the agreement comprises a contract. For example, the first advertiser 305A makes an agreement with the first DSP 306A, to which it is operably connected, to send to the DSP 306A a DSP bid 330A for an advertisement, the DSP bid 330A comprising a candidate advertisement. One or more of the DSPs 306A, 306B . . . 306Z, and the client DSP 220 then bid on an auction held by the SSP 312 by sending a DSP bid 330A, 330B . . . 330Z to the SSP 312. Alternatively, or additionally, the measurement platform 100 may bid in the auction by sending a measurement platform bid 335 to the SSP 312, the measurement platform bid 335 comprising an amount of money the measurement platform 100 offers to pay for the opportunity to display on the user device 308 a survey configured to measure performance of the winning advertisement 309, the measurement platform bid further comprising the survey.

Preferably, although not necessarily, the measurement platform bid 335 does not comprise a candidate advertisement. The SSP 312 then selects as a winning bid the bid that the SSP 312 determines is the highest bid in the auction. If a DSP 306A, 306B . . . 306Z (including the client DSP 220) wins the auction, the SSP 312 sells to the winning DSP the right to display the winning DSP's advertisement on the user device 308. The SSP 312 forwards the winning advertisement 309 to the user device 308 for display in the advertisement spot 302. Preferably, but not necessarily, the measurement platform 100 is configured to send to the client DSP 220 a metric 240 configured to measure performance of the winning advertisement 309. The metric 240 thereby measures an estimate of the advertisement's performance. For example, the metric 240 comprises one or more of purchase intent, end user brand awareness, and end user product consideration. Purchase intent comprises an estimate of likelihood of the end user purchasing the advertised brand. End user brand awareness comprises awareness of the end user of the advertised brand. End user product consideration comprises an estimate of consideration by the end user of the advertised brand.

The client DSP advertiser 230 then uses the metric 240 to ensure that the DSP 306A, 306B . . . 306Z sends the winning advertisement to the end users 210 most likely to engage with the winning advertisement.

For example, the end user data comprises one or more of personal end user data, user device data regarding the mobile device, an end user location, and other end user data. For example, the personal data comprises demographic data. For example, the user device data comprises one or more of a device make, a device model number, a device operating system, and another user device datum. The client DSP 220 uses the user data to select end users 210 most likely to engage with the winning advertisement 309. End users 210 that are selected as most likely to engage with the winning advertisement 309 are termed best users (not shown in FIG. 3). The client DSP 220 can select the best users in many ways. For example, the client DSP can use the end user data to select the requests from end users most likely to engage with the winning advertisement 309. For example, the client DSP 220 can use manual targeting where a human decides the best audience for the advertisement. Alternatively, or additionally, the client DSP 220 selects the best users using machine learning, where an algorithm learns features of the best users, that is, of the end users 210 that are the most likely to engage with the winning advertisement 309.

The measurement platform 100 receives an advertisement display notification 350 sent by the user device 308 upon the end user 210 seeing the winning advertisement 309 from the client DSP 220. The advertisement display notification 350 again comprises the exposed user identifier. The measurement platform 100 uses the received exposed user identifier to build an exposed group, that is a group of end user identifiers from which the measurement platform 100 has received the advertisement display notification 350.

Other than the measurement platform bid 335 that the measurement platform places, the DSP bid 330A, 330B . . . 330Z comprises a candidate advertisement that becomes a winning advertisement for the SSP to forward to the user device if the DSP bid 330A, 330B . . . 330Z of the DSP 306A, 306B . . . 306Z or of the client DSP 220 wins the auction. When the end user 210 completes a survey response 370, the end user 210 sends the survey response 370 to the measurement platform 100. By such a process the measurement platform 100 collects survey responses for the control and the exposed groups.

The measurement platform 100 is operably connected to the client DSP 220, the measurement platform 100 (using the report builder 195 shown in FIGS. 1-2, not shown in FIG. 3) configured to determine a metric 240 configured to measure performance of the advertisement of the client DSP 220. Preferably, but not necessarily, the metric 240 measures the performance using an engagement level of the end user 210 with the winning advertisement 309. The measurement platform 100 (using the report builder 195 shown in FIGS. 1-2, not shown in FIG. 3) is further configured to send the metric 240 to the client DSP 220.

FIG. 4 is a flow chart of a method 400 for measuring effectiveness of an advertisement using a measurement platform. More precisely, FIG. 4 is a flow chart of a method 400 for measuring effectiveness of an advertisement using a measurement platform.

The order of the steps in the method 400 is not constrained to that shown in FIG. 4 or described in the following discussion. Several of the steps could occur in a different order without affecting the final result.

Preferably, but not necessarily, the method 400 runs once every time a control group update period has been completed. For example, the control group update period comprises a fixed period of time. Alternatively, or additionally, the control group update period comprises a variable period of time. For example, where the control group update period comprises a fixed period of time, the control group builder updated the control group occur on a regular schedule predetermined by the control group update period. For example, the control group update period equals one hour. For example, the control group update period equals 24 hours. For example, the control group builder regularly checks whether a control group update period has been completed since one or more of a time of a last control group update and a beginning of a current run of the method for measuring the effectiveness of an advertisement using a measurement platform. Alternatively, or additionally, the control group update period equals zero, so that the method 400 effectively becomes a continuous process.

In step 405, the measurement platform, the measurement platform configured to measure performance of an advertisement, the measurement platform comprising a demand-side platform (DSP), the measurement platform further comprising a profile storage configured to store an end user profile, the end user profile comprising a set of features associated with the end user, the measurement platform further comprising a control group storage configured to store an identifier of a control user (“control user identifier”), the measurement platform further comprising a control group builder operably connected to the data platform, the control group builder configured to update the control group with similar statistical properties to an exposed group of end users (“exposed users”) that have seen the winning advertisement, receives an advertisement display notification notifying the measurement platform that a device under control of the end user (“user device”) has displayed to the end user a winning advertisement from a client DSP, the client DSP comprising a DSP of a client of the measurement platform, the winning advertisement having won an auction run by a supply-side platform (SSP) operably connected to the DSP, the advertisement display notification comprising an identifier of the end user. Block 405 then transfers control to block 410.

In step 410, the measurement platform stores the identifier of the exposed end user (“exposed user identifier”) in the exposed group. Block 410 then transfers control to block 415.

In step 415, the measurement platform updates the exposed group. Block 415 then transfers control to block 420.

In step 420, the control group builder updates, with a new control user identifier, a control group of end users with similar statistical properties to the exposed group except that the control group members (“control users”) have not seen the winning advertisement. Preferably, but not necessarily, the step of updating the control group comprises a sub-step of determining similarity of the control group and the exposed group using one or more of a feature of the control group and a feature of the exposed group. Preferably, but not necessarily, the step of updating the control group comprises an additional sub-step, performed after the determining similarity sub-step, of determining the similarity by determining an actual index vector, wherein the actual index vector comprises a difference between the end user profiles corresponding to the exposed user and the end user profiles corresponding to the control user. Preferably, but not necessarily, the step of updating the control group comprises an additional sub-step, performed after the determining the actual index vector sub-step, of selecting an end user profile that minimizes a difference between the actual index vector and an ideal index vector, wherein the ideal index vector comprises a vector having a length equal to a length of the actual index vector, wherein each element of the ideal index vector equals 0. Preferably, but not necessarily, the sub-step of minimizing a difference between the actual index vector and an ideal index vector comprises selecting the end user profile that minimizes a statistical difference between the control group and the exposed group. Preferably, but not necessarily, an actual index vector component of 0 for a feature of interest indicates that the feature is equally represented in the control group and the exposed group, an actual index vector component greater than 0 indicates that the feature of interest is under-represented in the control group relative to the exposed group, and an actual index vector component less than 0 indicates that the feature of interest is over-represented in the control group relative to the exposed group.

For example, the step of updating the control group comprises the following sub-steps: retrieving, by the control group builder, a selected portion of the exposed user identifiers; retrieving, by the control group builder, a selected portion of the control user identifiers; retrieving, by the control group builder, a selected portion of the end user profiles comprised in the profile storage; encoding, by the control group builder, an end user profile into a binary feature vector, wherein at least one element of the binary feature vector equals 0 or 1; sorting, by the control group builder, the binary feature vector into one of a group comprising exposed binary feature vectors (“an exposed binary feature vector group”), a group comprising control binary feature vectors (“a control binary feature vector group”), and a control pool comprising all available binary feature vectors that are not comprised in one or more of the exposed binary feature vector group and the control binary feature vector group; determining, by the control group builder, using the exposed binary feature vector group and using the control binary feature vector group, an actual index vector, the actual index vector comprising a measure of a difference between the binary feature vectors corresponding to the exposed users (“exposed binary feature vectors”) and the binary feature vectors corresponding to the control users (“control binary feature vectors”); determining, by the control group builder, a dot product between the actual index vector and a binary feature vector comprised in the control pool; storing, by the control group builder, the dot product in the control group storage; selecting, by the control group builder, a best control binary feature vector having a maximum value of the dot product; and transferring, by the control group builder, the best control binary feature vector from the control pool to the control group. Block 420 then transfers control to block 430.

In step 430, the control group builder stores the identifier of the new control user (“control user identifier”) in the control group storage. Block 430 then transfers control to block 440.

In step 440, the measurement platform receives a measurement platform advertisement request copy from the SSP. Block 440 then transfers control to block 450.

In step 450, the measurement platform sends to the end user a survey configured to measure performance of the advertisement. Block 450 then transfers control to block 460.

In step 460, the measurement platform receives a response to the survey from the end user. Block 460 then transfers control to block 470.

In step 470, the measurement platform determines a metric measuring performance of the winning advertisement. Preferably, but not necessarily, the determining step comprises using a difference between exposed group responses and control group responses. Block 470 then transfers control to block 480.

In step 480, the measurement platform sends the metric to the client DSP. Block 480 then terminates the process.

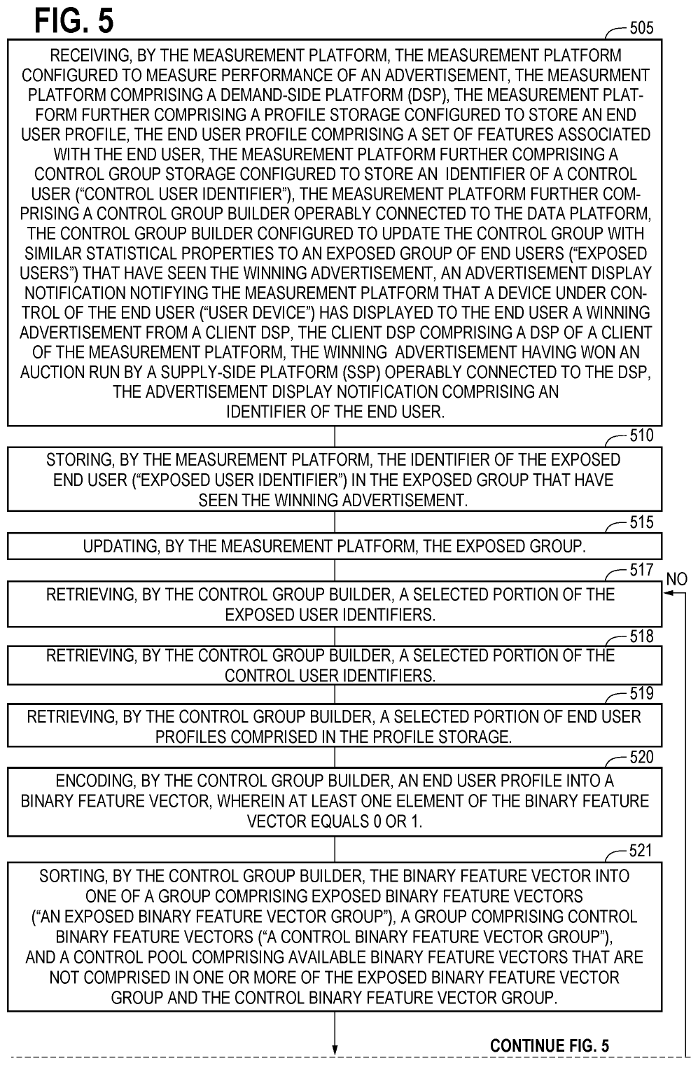

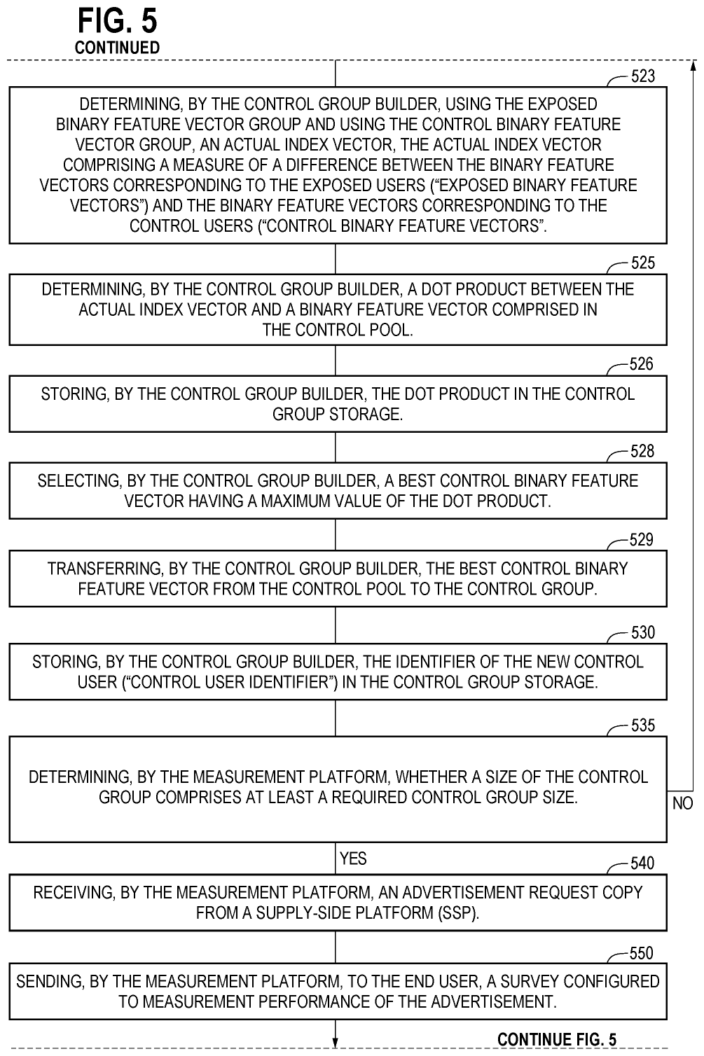

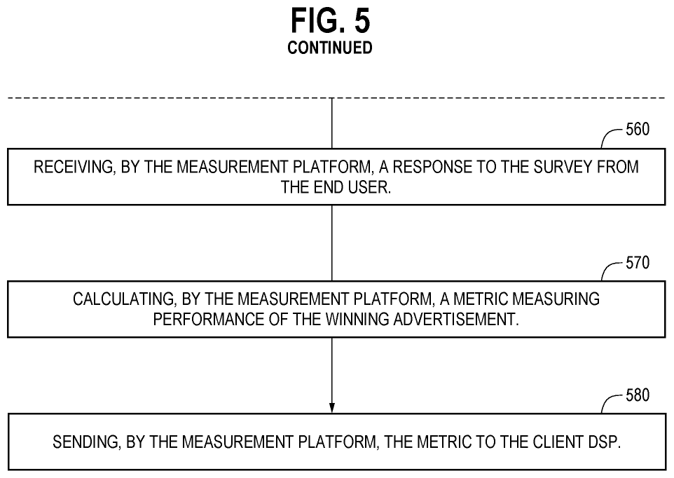

FIG. 5 is a flow chart of a method 500 for measuring effectiveness of an advertisement, using a measurement platform. More precisely, FIG. 5 is a flow chart of a method 500 for measuring effectiveness of an advertisement using a measurement platform.

The order of the steps in the method 500 is not constrained to that shown in FIG. 5 or described in the following discussion. Several of the steps could occur in a different order without affecting the final result.

Preferably, but not necessarily, the method 500 runs once every time a control group update period has been completed. For example, the control group update period comprises a fixed period of time. Alternatively, or additionally, the control group update period comprises a variable period of time. For example, where the control group update period comprises a fixed period of time, the control group builder updated the control group occur on a regular schedule predetermined by the control group update period. For example, the control group update period equals one hour. For example, the control group update period equals 24 hours. For example, the control group builder regularly checks whether a control group update period has been completed since one or more of a time of a last control group update and a beginning of a current run of the method for measuring the effectiveness of an advertisement using a measurement platform. Alternatively, or additionally, the control group update period equals zero, so that the method 500 effectively becomes a continuous process.

In step 505, the measurement platform, the measurement platform configured to measure performance of an advertisement, the measurement platform comprising a demand-side platform (DSP), the measurement platform further comprising a profile storage configured to store an end user profile, the end user profile comprising a set of features associated with the end user, the measurement platform further comprising a control group storage configured to store an identifier of a control user (“control user identifier”), the measurement platform further comprising a control group builder operably connected to the data platform, the control group builder configured to update the control group with similar statistical properties to an exposed group of end users (“exposed users”) that have seen the winning advertisement, receives an advertisement display notification notifying the measurement platform that a device under control of the end user (“user device”) has displayed to the end user a winning advertisement from a client DSP, the client DSP comprising a DSP of a client of the measurement platform, the winning advertisement having won an auction run by a supply-side platform (SSP) operably connected to the DSP, the advertisement display notification comprising an identifier of the end user. Block 505 then transfers control to block 510.

In step 510, the measurement platform stores the identifier of the exposed end user (“exposed user identifier”) in the exposed group. Block 510 then transfers control to block 515.

In step 515, the measurement platform updates the exposed group. Block 515 then transfers control to block 517.

In step 517, the control group builder retrieves a selected portion of the exposed user identifiers. Preferably but not necessarily, the control group builder retrieves randomly selected exposed user identifiers. More preferably, but not necessarily, the control group builder retrieves all available exposed user identifiers. Block 517 then transfers control to block 518.

In step 518, the control group builder retrieves a selected portion of the control user identifiers. Preferably, but not necessarily, the control group builder retrieves selected control user identifiers. More preferably, but not necessarily, the control group builder retrieves randomly selected control user identifiers. Most preferably, but not necessarily, the control group builder retrieves all available control user identifiers. Block 518 then transfers control to block 519.

In step 519, the control group builder retrieves a selected portion of the end user profiles comprised in the profile storage. Preferably, but not necessarily, the control group builder randomly retrieves a selected portion of the end user profiles comprised in the profile storage. Alternatively, or additionally, retrieves a selected portion of the end user profiles comprised in the profile storage. For example, the control group builder retrieves every mth profile of end user profiles comprised in the profile storage, where m is a configurable parameter. Block 519 then transfers control to block 520.

In step 520, the control group builder encodes an end user profile into a binary feature vector, wherein at least one element of the binary feature vector equals 0 or 1. More preferably, but not necessarily, each element of the binary feature vector equals 0 or 1. Preferably, but not necessarily, the encoding step comprises encoding each of the available end user profiles into a respective binary feature vector. Most preferably, but not necessarily, the encoding step comprises encoding the end user profile using one-hot-encoding. Each end user profile contains many features. For example, city, device type, operating system, time of day, etc. The control group builder decomposes the features into binary feature vectors using the one-hot-encoding mechanism. One-hot-encoding comprises a binary representation of categorical variables. At least one category is assigned a unique binary code. For that category, one bit is activated and set to 1, while all other bits are set to 0 for that category. For example, using the one-hot-encoding system, the control group builder encodes/represents cities as binary feature vectors. For example, if there are three possible values for the feature city, then using the one-hot-encoding system, the control group builder represents London as a binary feature vector [1, 0, 0], represents New York as a binary feature vector [0, 1, 0], and represents Paris as a binary feature vector [0, 0, 1]. Block 520 then transfers control to block 521.

In step 521, the control group builder sorts the binary feature vector into one of a group comprising exposed binary feature vectors (“an exposed binary feature vector group”), a group comprising control binary feature vectors (“a control binary feature vector group”), and a control pool comprising all available binary feature vectors. Preferably, but not necessarily, the control group builder sorts all available binary feature vectors. The control group builder thereby creates the exposed binary feature vector group, the control binary feature vector group, and the control pool. The exposed binary feature vector group comprises binary feature vectors having an end user identifier matching an end user identifier in the exposed group storage. The control binary feature vector group comprises binary feature vectors having an end user identifier matching an end user identifier in the control group storage. The control binary feature vector group comprises one or more of a previously updated control binary feature vector group and an empty binary feature vector control group if the control group builder has not previously updated the control group. Block 521 then transfers control to block 523.

In step 523, the control group builder, using the exposed binary feature vector group and using the control binary feature vector group, determines an actual index vector, the actual index vector comprising a measure of a difference between the binary feature vectors corresponding to the exposed users (“exposed binary feature vectors”) and the binary feature vectors corresponding to the control users (“control binary feature vectors”). An actual index vector element equal to 0 for a particular feature of interest indicates that this feature is equally represented in the control group and the exposed group. An actual index vector element greater than 0 indicates that the feature of interest is under-represented in the control group relative to the exposed group. An actual index vector element less than 0 indicates that the feature of interest is over-represented in the control group relative to the exposed group.

A number of elements comprised in the actual index vector is equal to a number of elements comprised in the binary feature vectors that the control group builder uses to determine the actual index vector. The binary feature vectors comprise both exposed binary feature vectors and control binary feature vectors. The control group builder determines an ith element of the actual index vector using an equation:

$$actual\_index {\_vector}_{i} = ln ( \frac{( {expCount}_{i}^{⋆} numConBFVectors )}{( {conCount}_{{i}^{⋆}} numExpBFVectors )} ) , \qquad ( 1 )$$

wherein:
expCountᵢ=a count of 1's comprised in an ith element of the exposed binary feature vector;
conCountᵢ=a count of 1's comprised in respective ith element of the control binary feature vectors;
numConBFVectors=number of binary feature vectors comprised in the control group; and
numExpBFVectors=number of binary feature vectors comprised in the exposed group.

As a simplified example, let us postulate that the control group comprises three binary feature vectors and the exposed group comprises three binary feature vectors. In this example, the control binary feature vectors are {[1, 0, 0, 1, 0], [0, 1, 0, 1, 0], and [0, 0, 1, 0, 1]}. In this example, the exposed binary feature vectors are {[0, 1, 0, 0, 1], [1, 0, 0, 1, 0], [1, 0, 0, 0, 1]}. In this example, the first three elements of the binary feature vector comprise possible cities, London, New York, Paris. If the first element of the binary feature vector equals 1, this means that the city of the user that corresponds to the binary feature vector is London. If the second element of the binary feature vector equals 1, this means that the city of the user that corresponds to the binary feature vector is New York. If the third element of the binary feature vector equals 1, this means that the city of the user that corresponds to the binary feature vector is Paris.

For example, the fourth and fifth elements of the binary feature vector indicate a type of operating system of the user device, one or more of Android and iOS. If the fourth element of the binary feature vector equals 1, this means that the user's operating system is Android. If the fifth element of the binary feature vector equals 1, this means that the user's operating system is iOS. Hence, the first control profile, [1, 0, 0, 1, 0], indicates that the user's city is London and the user's operating system is Android. Similarly, the second control profile, [0. 1, 0, 1, 0], indicates that the user's city is New York and the user's operating system is Android. The third control profile, [0, 0, 1, 0, 1], indicates that the user's city is Paris and the user's operating system is iOS. In this example, the control group builder creates binary feature vectors that each comprise five elements. Therefore, the control group builder determines an actual index vector that also comprises five elements. For example, the control group builder determines the actual index vector using equation (1) and employing a logarithm with a base comprising one or more of e, 10, and 2. Block 523 then transfers control to block 525.

In step 525, the control group builder determines a dot product between the actual index vector and a binary feature vector comprised in the control pool. Preferably, but not necessarily, the control group builder determines a dot product between the actual index vector and each binary feature vector comprised in the control pool. For example, the control group builder iteratively works its way through each binary feature vector comprised in the control pool, and for each one, the control group builder computes a dot product of the actual index vector and the binary feature vector.

For example, the actual index vector=[0.693, 0. 0, 0.0, −0.693, 0.693]. For example, the control pool binary feature vector=[1, 0, 0, 0, 1].

The control group builder determines that the dot_product (actual index vector, binary feature vector)=1*0.693+1*0.693=1.386. Block 525 then transfers control to block 526.

In step 526, the control group builder stores the dot product in the control group storage. Block 526 then transfers control to block 528.

In step 528, the control group builder selects a best control binary feature vector having a maximum value of the dot product. Block 528 then transfers control to block 529.

In step 529, the control group builder transfers the best control binary feature vector from the control pool to the control group. Block 529 then transfers control to block 530.

In step 530, the control group builder stores the identifier of the new control user (“control user identifier”) in the control group storage. Block 530 then transfers control to block 535.

In step 535, the control group builder checks if a size of the control group comprises at least a required control group size. Preferably, but not necessarily, the required control group size comprises a size of the exposed group. Alternatively, or additionally, the client DSP determines the required control group size. If no, the process reverts to block 517. If yes, block 535 then transfers control to block 540.

In step 540, the measurement platform receives a measurement platform advertisement request copy from the SSP. Block 540 then transfers control to block 550.

In step 550, the measurement platform sends to the end user a survey configured to measure performance of the advertisement. Block 550 then transfers control to block 560.

In step 560, the measurement platform receives a response to the survey from the end user. Block 560 then transfers control to block 570.

In step 570, the measurement platform determines a metric measuring performance of the winning advertisement. Block 570 then transfers control to block 580.

In step 580, the measurement platform sends the metric to the client DSP. Block 580 then terminates the process.

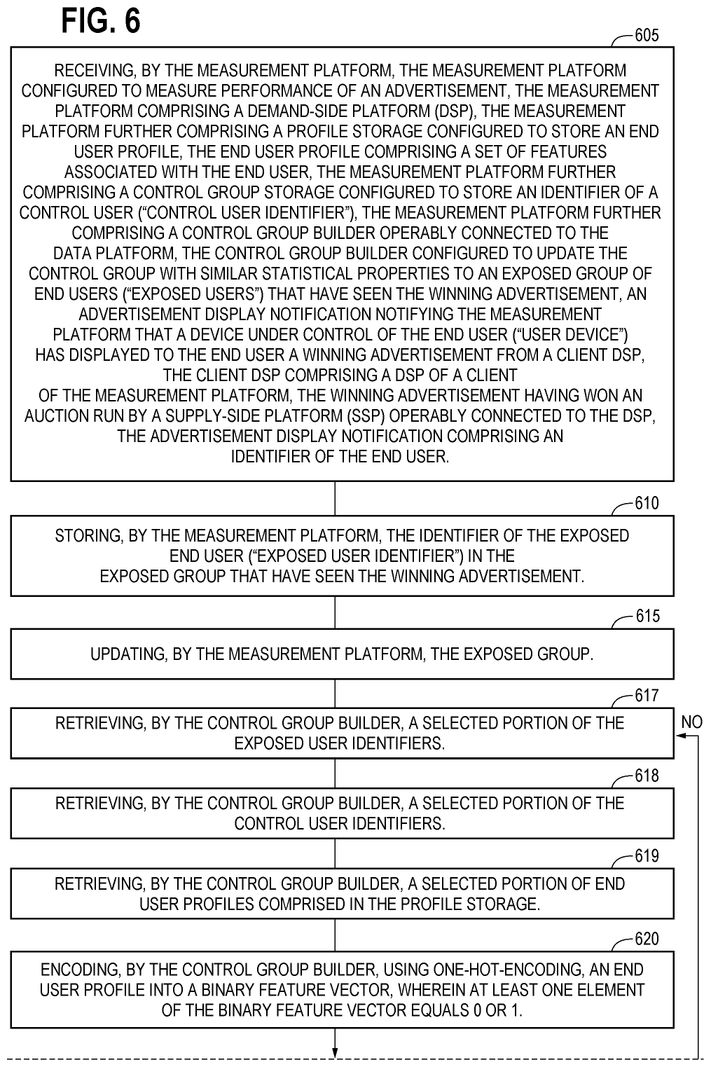

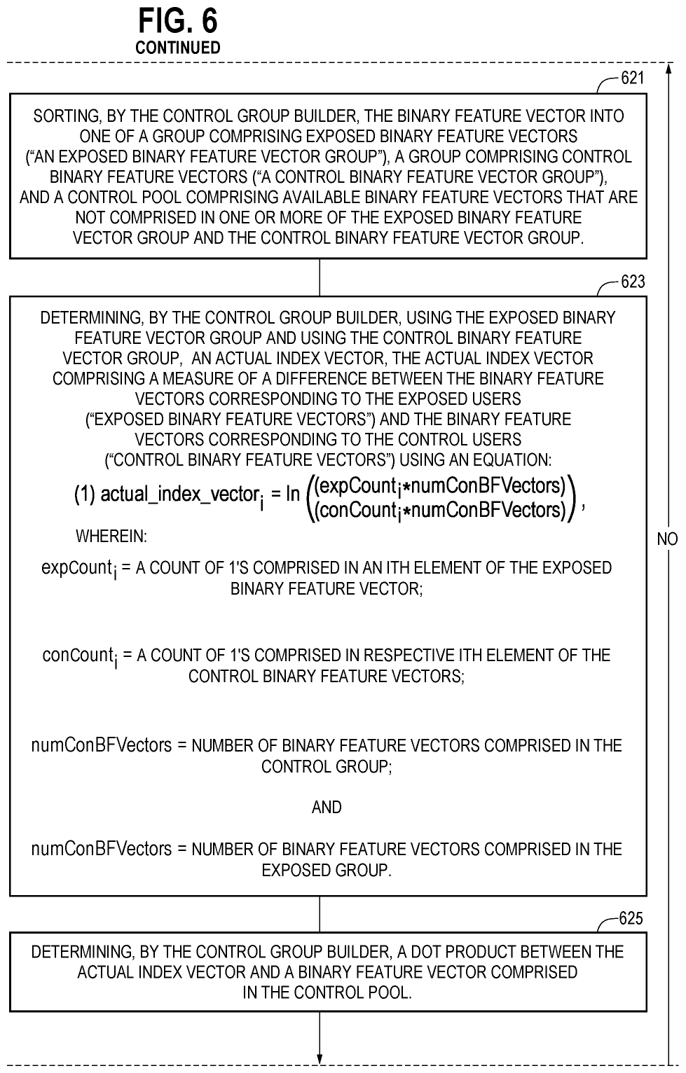

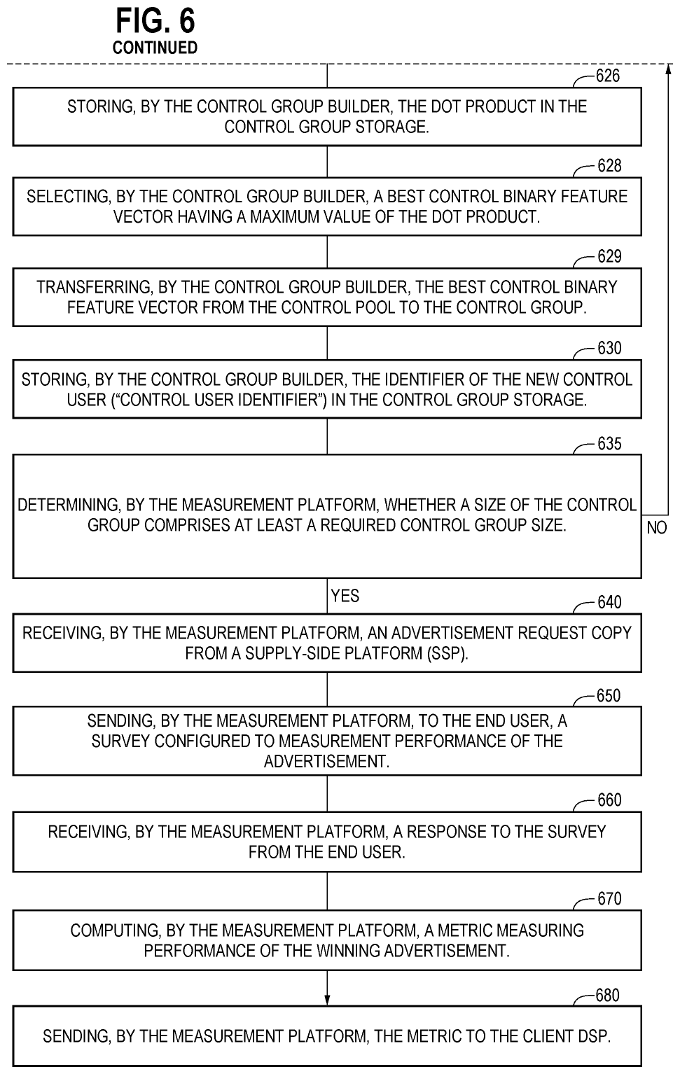

FIG. 6 is a flow chart of a method 600 for measuring effectiveness of an advertisement, using a measurement platform. More precisely, FIG. 6 is a flow chart of a method 600 for measuring effectiveness of an advertisement using a measurement platform.

The order of the steps in the method 600 is not constrained to that shown in FIG. 6 or described in the following discussion. Several of the steps could occur in a different order without affecting the final result.

Preferably, but not necessarily, the method 600 runs once every time a control group update period has been completed. For example, the control group update period comprises a fixed period of time. Alternatively, or additionally, the control group update period comprises a variable period of time. For example, where the control group update period comprises a fixed period of time, the control group builder updated the control group occur on a regular schedule predetermined by the control group update period. For example, the control group update period equals one hour. For example, the control group update period equals 24 hours. For example, the control group builder regularly checks whether a control group update period has been completed since one or more of a time of a last control group update and a beginning of a current run of the method for measuring the effectiveness of an advertisement using a measurement platform. Alternatively, or additionally, the control group update period equals zero, so that the method 600 effectively becomes a continuous process.

In step 605, the measurement platform, the measurement platform configured to measure performance of an advertisement, the measurement platform comprising a demand-side platform (DSP), the measurement platform further comprising a profile storage configured to store an end user profile, the end user profile comprising a set of features associated with the end user, the measurement platform further comprising a control group storage configured to store an identifier of a control user (“control user identifier”), the measurement platform further comprising a control group builder operably connected to the data platform, the control group builder configured to update the control group with similar statistical properties to an exposed group of end users (“exposed users”) that have seen the winning advertisement, receives an advertisement display notification notifying the measurement platform that a device under control of the end user (“user device”) has displayed to the end user a winning advertisement from a client DSP, the client DSP comprising a DSP of a client of the measurement platform, the winning advertisement having won an auction run by a supply-side platform (SSP) operably connected to the DSP, the advertisement display notification comprising an identifier of the end user. Block 605 then transfers control to block 610.

In step 610, the measurement platform stores the identifier of the exposed end user (“exposed user identifier”) in the exposed group. Block 610 then transfers control to block 615.

In step 615, the measurement platform updates the exposed group. Block 615 then transfers control to block 617.

In step 617, the control group builder retrieves a selected portion of the exposed user identifiers. Preferably, but not necessarily, the control group builder retrieves randomly selected exposed user identifiers. More preferably, but not necessarily, the control group builder retrieves all available exposed user identifiers. Block 617 then transfers control to block 618.

In step 618, the control group builder retrieves a selected portion of the control user identifiers. Preferably, but not necessarily, the control group builder retrieves selected control user identifiers. More preferably, but not necessarily, the control group builder retrieves randomly selected control user identifiers. Most preferably, but not necessarily, the control group builder retrieves all available control user identifiers. Block 618 then transfers control to block 619.

In step 619, the control group builder retrieves a selected portion of the end user profiles comprised in the profile storage. Preferably, but not necessarily, the control group builder randomly retrieves a selected portion of the end user profiles comprised in the profile storage. Alternatively, or additionally, retrieves a selected portion of the end user profiles comprised in the profile storage. For example, the control group builder retrieves every mth profile of end user profiles comprised in the profile storage, where m is a configurable parameter. Block 619 then transfers control to block 620.

In step 620, using one-hot-encoding, the control group builder encodes an end user profile into a binary feature vector, wherein at least one element of the binary feature vector equals 0 or 1. More preferably, but not necessarily, each element of the binary feature vector equals 0 or 1. Preferably, but not necessarily, the encoding step comprises encoding each of the available end user profiles into a respective binary feature vector. Most preferably, but not necessarily, the encoding step comprises encoding the end user profile using one-hot-encoding. Each end user profile contains many features. For example, city, device type, operating system, time of day, etc. The control group builder decomposes the features into binary feature vectors using the one-hot-encoding mechanism. One-hot-encoding comprises a binary representation of categorical variables. At least one category is assigned a unique binary code. For that category, one bit is activated and set to 1, while all other bits are set to 0 for that category. For example, using the one-hot-encoding system, the control group builder encodes/represents cities as binary feature vectors. For example, if there are three possible values for the feature city, then using the one-hot-encoding system, the control group builder represents London as a binary feature vector [1, 0, 0], represents New York as a binary feature vector [0, 1, 0], and represents Paris as a binary feature vector [0, 0, 1]. Block 620 then transfers control to block 621.

In step 621, the control group builder sorts the binary feature vector into one of a group comprising exposed binary feature vectors (“an exposed binary feature vector group”), a group comprising control binary feature vectors (“a control binary feature vector group”), and a control pool comprising all available binary feature vectors. Preferably, but not necessarily, the control group builder sorts all available binary feature vectors. The control group builder thereby creates the exposed binary feature vector group, the control binary feature vector group, and the control pool. The exposed binary feature vector group comprises binary feature vectors having an end user identifier matching an end user identifier in the exposed group storage. The control binary feature vector group comprises binary feature vectors having an end user identifier matching an end user identifier in the control group storage. The control binary feature vector group comprises one or more of a previously updated control binary feature vector group and an empty binary feature vector control group if the control group builder has not previously updated the control group. Block 621 then transfers control to block 623.

In step 623, the control group builder, using the exposed binary feature vector group and using the control binary feature vector group, determines an actual index vector, the actual index vector comprising a measure of a difference between the binary feature vectors corresponding to the exposed users (“exposed binary feature vectors”) and the binary feature vectors corresponding to the control users (“control binary feature vectors”) using an equation (1):

$$actual\_index {\_vector}_{i} = ln ( \frac{( {expCount}_{i}^{⋆} numConBFVectors )}{( {conCount}_{{i}^{⋆}} numExpBFVectors )} ) , \qquad ( 1 )$$

wherein:
expCountᵢ=a count of 1's comprised in an ith element of the exposed binary feature vector;
conCountᵢ=a count of 1's comprised in respective ith element of the control binary feature vectors;
numConBFVectors=number of binary feature vectors comprised in the control group; and
numExpBFVectors=number of binary feature vectors comprised in the exposed group.

An actual index vector element equal to 0 for a particular feature of interest indicates that this feature is equally represented in the control group and the exposed group. An actual index vector element greater than 0 indicates that the feature of interest is under-represented in the control group relative to the exposed group. An actual index vector element less than 0 indicates that the feature of interest is over-represented in the control group relative to the exposed group.

A number of elements comprised in the actual index vector is equal to a number of elements comprised in the binary feature vectors that the control group builder uses to determine the actual index vector. The binary feature vectors comprise both exposed binary feature vectors and control binary feature vectors.

As a simplified example, let us postulate that the control group comprises three binary feature vectors and the exposed group comprises three binary feature vectors. In this example, the control binary feature vectors are {[1, 0, 0, 1, 0], [0, 1, 0, 1, 0], and [0, 0, 1, 0, 1]}. In this example, the exposed binary feature vectors are {[0, 1, 0, 0, 1], [1, 0, 0, 1, 0], [1, 0, 0, 0, 1]}. In this example, the first three elements of the binary feature vector comprise possible cities, London, New York, Paris. If the first element of the binary feature vector equals 1, this means that the city of the user that corresponds to the binary feature vector is London. If the second element of the binary feature vector equals 1, this means that the city of the user that corresponds to the binary feature vector is New York. If the third element of the binary feature vector equals 1, this means that the city of the user that corresponds to the binary feature vector is Paris.

For example, the fourth and fifth elements of the binary feature vector indicate a type of operating system of the user device, one or more of Android and iOS. If the fourth element of the binary feature vector equals 1, this means that the user's operating system is Android. If the fifth element of the binary feature vector equals 1, this means that the user's operating system is iOS. Hence, the first control profile, [1, 0, 0, 1, 0], indicates that the user's city is London and the user's operating system is Android. Similarly, the second control profile, [0. 1, 0, 1, 0], indicates that the user's city is New York and the user's operating system is Android. The third control profile, [0, 0, 1, 0, 1], indicates that the user's city is Paris and the user's operating system is iOS. In this example, the control group builder creates binary feature vectors that each comprise five elements. Therefore, the control group builder determines an actual index vector that also comprises five elements. For example, the control group builder determines the actual index vector using equation (1) and employing a logarithm with a base comprising one or more of e, 10, and 2. Block 623 then transfers control to block 625.

In step 625, the control group builder determines a dot product between the actual index vector and a binary feature vector comprised in the control pool. Preferably, but not necessarily, the control group builder determines a dot product between the actual index vector and each binary feature vector comprised in the control pool. For example, the control group builder iteratively works its way through each binary feature vector comprised in the control pool, and for each one, the control group builder computes a dot product of the actual index vector and the binary feature vector.

For example, the actual index vector=[0.693, 0. 0, 0.0, −0.693, 0.693].

For example, the control pool binary feature vector=[1, 0, 0, 0, 1].
The control group builder determines that the dot_product (actual index vector, binary feature vector)=1*0.693+1*0.693=1.386. Block 625 then transfers control to block 626.

In step 626, the control group builder stores the dot product in the control group storage. Block 626 then transfers control to block 628.

In step 628, the control group builder selects a best control binary feature vector having a maximum value of the dot product. Block 628 then transfers control to block 629.

In step 629, the control group builder transfers the best control binary feature vector from the control pool to the control group. Block 629 then transfers control to block 630.

In step 630, the control group builder stores the identifier of the new control user (“control user identifier”) in the control group storage. Block 630 then transfers control to block 635.

In step 635, the control group builder checks if a size of the control group comprises at least a required control group size. Preferably, but not necessarily, the required control group size comprises a size of the exposed group. Alternatively, or additionally, the client DSP determines the required control group size. If no, the process reverts to block 617. If yes, block 635 then transfers control to block 640.

In step 640, the measurement platform receives a measurement platform advertisement request copy from the SSP. Block 640 then transfers control to block 650.

In step 650, the measurement platform sends to the end user a survey configured to measure performance of the advertisement. Block 650 then transfers control to block 660.

In step 660, the measurement platform receives a response to the survey from the end user. Block 660 then transfers control to block 670.

In step 670, the measurement platform determines a metric measuring performance of the winning advertisement. Block 670 then transfers control to block 680. In step 680, the measurement platform sends the metric to the client DSP. Block 680 then terminates the process.

FIG. 7A shows the typical placing of a winning advertisement in the reserved advertising spot 302 on the user device 308. This advertising space may be populated by one or more of the winning advertisement and a survey configured to measure the performance of the winning advertisement.

FIG. 7B shows an example of a survey that may be displayed in the reserved advertising spot 302 in FIG. 7A.

### Experimental Results

We collected real data collected while running advertisements using embodiments of the invention and using three prior art methods. The advertisement collected 4,000 exposed user identifiers.

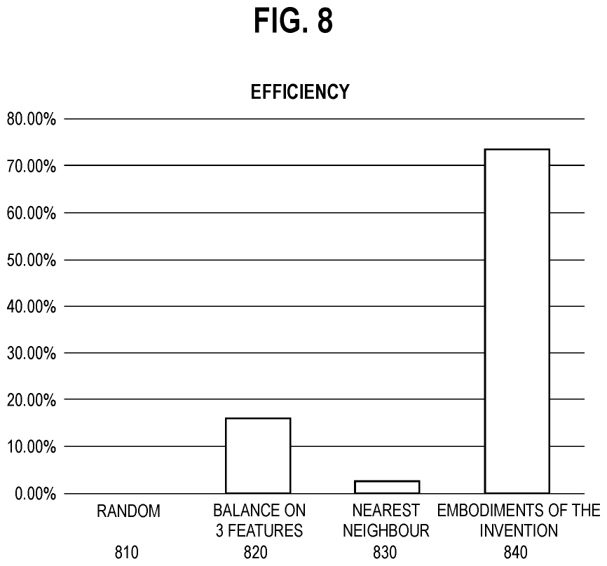

The profile storage used for this experiment contains end user profiles for approximately 2 billion active end users. Each end user profile contains 52 features, for example, device type, location, device operation system, and the like. For each identifier in the exposed group, an end user profile was retrieved. For the control pool, 100,000 end user profiles were randomly selected. We ran each of the four processes, that is, the one using embodiments of the invention and the three prior art methods, twenty times on the same exposed group and on randomly selected control pools. We ran the four processes on the exposed group using the same control pool for each run. We carried out twenty different experimental runs. In each experimental run, the exposed group was the same, a different control pool was randomly chosen (and used for the four processes), and precisely the same four processes were applied in the twenty different runs. After we completed the experimental runs, we averaged the results to produce Table 1 and FIG. 8. Accordingly, the experimental results seen resulted from the superiority of embodiments of the invention and not from any other factor such as a chance selection of a control pool that was not truly randomized. This experiment represents a realistic test of the performance relative to prior art methods when one is using embodiments of the invention.

The prior art processes used were:

1. Random. The control group was formed from a random selection of 4,000 end user profiles from the control pool. This provides a lower bound for performance against which to measure the performance of the other processes. For a large enough number of end user profiles, the efficiency of the prior art random process will be 0%, as was found in this experiment. The prior art random process simply uses a random selection of a large number of end user profiles from the control pool so the efficiency of the prior art random process can be expected to be zero.

2. Balanced matching of three features. Within the exposed group, the three most discriminatory features were chosen. These are the features that divide the population into the highest number of groups wherein no single feature value applies to more than 50% of the exposed group. The control group is built using a small set of features commonly applied in marketing, such as age, gender and location. All other features are ignored.

3. Nearest neighbor. End user profiles were chosen one by one from the exposed group. The control pool was searched for the closest end user profile to an exposed user as measured by the Manhattan distance. This closest control group profile was then added to the control group.

Performance was measured by the absolute difference between the count of the number of values of each feature in the control compared to the number in the exposed. For example, take the feature city=New York, If the count in the control group was 20 and the count in the exposed group=22, then the difference is 2. We summed counts across all values of all features in the data to obtain a total equaling a raw absolute difference. Additionally, we calculated a difference per control group member in the count of the number of values of each feature. This last quantity can be thought of as the number of differences per binary feature vector. Lastly, we calculated an efficiency of

efficiency=1−abs_diff/abs_diff_random,

where:
abs_diff=the total number of differences between counts of every feature in the binary feature vectors of the control group and the exposed group. This numerator is determined according to each of the three prior art techniques and using embodiments of the. Invention;
abs_diff_random=the total number of differences between counts of every feature in the binary feature vectors of the random control group and the exposed group. This denominator has the same value when computing efficiency for each of the three prior art techniques and for embodiments of the invention;
efficiency=0% means the performance was no better than random, and
efficiency=100% means the control group was identical to the exposed.

| | | | | embodiments |
|---|---|---|---|---|
| | | balance on | nearest | of the |
| | random | 3 features | neighbour | invention |
| abs diff | 15967 | 13417 | 15568 | 4237 |
| diff per profile | 3.99 | 3.35 | 3.89 | 1.06 |
| efficiency | 0.00% | 15.97% | 2.50% | 73.47% |

FIG. 7 is a bar graph representing graphically the experimental results of the experiment measuring performance of embodiments of the invention relative to the three prior art processes and demonstrating superior performance of embodiments of the invention. A perfect process would generate an efficiency of 100%. The prior art random process 810 has an efficiency of 0%. The prior art process of balanced matching of three features 820 has an efficiency of 15.84%. The prior art nearest neighbor process 830 has an efficiency of 2.32%. Embodiments of the invention 840 exhibit an efficiency of 73.44%, a vast improvement over the efficiency of the three prior art processes. These experimental results were derived from real data pertaining to real end users. This experiment demonstrates that using embodiments of the invention is far superior to any of the three prior art methods.

An advantage of embodiments of the invention is that the novel use of the actual index vector ensures that if, at any point, there is bias between the control and exposed group (for example, if the control group has a greater proportion of end users with a certain brand of mobile phone than the exposed group has), then the next addition to the control group will be an end user profile that eliminates this bias as far as possible.

An advantage of embodiments of the invention is that the performance of the digital advertisement run by the client DSP can be objectively measured.

Another advantage of embodiments of the invention is that the performance of the digital advertisement can be objectively measured, in real-time.

Another advantage of embodiments of the invention is that by measuring the performance of a digital advertisement, the advertisement can be one or more of adjusted and optimized to maximize the performance of the advertisement. A further advantage of embodiments of the invention is that the one or more of adjustment and optimization can happen in real time. (This can be done by changing the target audience, changing the time of day it is displayed, etc. Or even stopping the advertisement.)

Another advantage of embodiments of the invention is that the measurement of the performance of the digital advertisement is based on surveys and can thus measure advertising goals like brand awareness and purchase intent that are not possible with standard metrics such as click-through or video view.

Another advantage of embodiments of the invention is that the measurement platform provides measurement of the performance of a digital advertisement using a control group which has been shown in experimental tests included in this application to be far more accurate that state-of-the-art methods to select a control group.

Another advantage of embodiments of the invention is that the measurement platform updates the control group in an incremental way. That is during the digital advertisement, as more people are exposed to the advertisement, so the control group grows in lockstep, without the need for redetermination of the control group from scratch each time the control group needs to be updated.

Another advantage of embodiments of the invention is that the novel use of a logarithm function in the actual index vector ensures that in cases where there are no exposed users with a particular feature value (for example, an advertisement may be geographically targeted to particular states for legal reasons) then embodiments of the invention ensure that there will be no control users with that particular feature value. By contrast, this advantage is not achievable using the prior art methods such as nearest neighbor. This is an important innovation because if the winning advertisement targets only specific locations, then this will ensure that the control group also adheres to the same strict limits.

A further advantage of embodiments of the invention is that by selecting a best control binary feature vector having a maximum value of the dot product, the control group builder ensures that the next binary feature vector chosen is the binary feature vector than minimizes any difference between the exposed and the growing control group.

Any logic or application described herein that comprises software or code can be embodied in any non-transitory computer-readable medium for use by or in connection with an instruction execution system in a computer system or other system. In this sense, the logic may comprise, for example, statements including instructions and declarations that can be fetched from the computer-readable medium and can be executed by the instruction execution system. In the context of the present disclosure, a computer-readable medium can be any medium that can contain, store, or update the logic or application described herein for use by or in connection with the instruction execution system. For example, the computer-readable medium may comprise one or more of random access memory (RAM), read-only memory (ROM), hard disk drive, solid-state drive, USB flash drive, memory card, floppy disk, optical disc such as compact disc (CD) or digital versatile disc (DVD), magnetic tape, and other memory components. For example, the RAM may comprise one or more of static random access memory (SRAM), dynamic random access memory (DRAM), magnetic random access memory (MRAM), and other forms of RAM. For example, the ROM may comprise one or more of programmable read-only memory (PROM), erasable programmable read-only memory (EPROM), electrically erasable programmable read-only memory (EEPROM), and other forms of ROM.

The Appendix contains pseudocode for the method to update an exposed group comprising end users that have seen a winning advertisement and to update a control group with control group members having similar statistical properties to members of the exposed group except that the control group members have not seen the winning advertisement.

While the above representative embodiments have been described with certain components in exemplary configurations, it will be understood by one of ordinary skill in the art that other representative embodiments can be implemented using different configurations and/or different components. For example, it will be understood by one of ordinary skill in the art that the order of certain steps and certain components can be altered without substantially impairing the functioning of the invention.

The representative embodiments and disclosed subject matter, which have been described in detail herein, have been presented by way of example and illustration and not by way of limitation. It will be understood by those skilled in the art that various changes may be made in the form and details of the described embodiments resulting in equivalent embodiments that remain within the scope of the invention. It is intended, therefore, that the subject matter in the above description shall be interpreted as illustrative and shall not be interpreted in a limiting sense.

### APPENDIX

Following is pseudocode for the method and system, using a measurement platform, to update a control group with control group members having similar statistical properties to members of an exposed group except that the control group members have not seen a winning advertisement and the exposed group members have seen the winning advertisement. Explicitly, it shows a practical encoding of equation (1) to determine the actual_index_vector.

```
def calc_actual_index_vector(expCoiunts, conCounts,
numExpBFVectors,
numConBFVectors):
  for i in range(len(actual_index_vector)):
    rrExp = 1.0 * expCounts[i] / num ExpBFVectors
    rrCon = 1.0 * conCounts[i] / numConBFVectors
    if rrExp == 0.0:
    actual_index_vector[i] = −1.0e32 # approximates In(0)
    elif rrCon == 0:
    actual_index_vector[i] = In(1.0e32) #Big value to avoid division
    by zero
    else:
    actual_index_vector[i] = In(rrExp / rrCon)
  return actual_index_vector
```

where:
actual_index_vector is the actual index vector being determined
len(actual_index_vector) is the number of elements of the actual index vector. This is equal to the number of elements in the binary feature vectors
numExpBFVectors is the number of binary feature vectors in the exposed group
numConBFVectors is the number of binary feature vectors in the control group
actual_index_vector[i] is the index value for the ith binary feature

1. A measurement platform configured to measure performance of an advertisement, the measurement platform comprising a demand-side platform (DSP), the measurement platform configured to send to an end user a survey configured to measure the advertisement's performance on behalf of a client DSP, the client DSP comprising a DSP of a client of the measurement platform, wherein the measurement platform is further configured to receive an advertisement display notification, the advertisement display notification notifying the measurement platform that a device under control of the end user (“user device”) has displayed to the end user a winning advertisement from the client DSP that wins an auction run by a supply-side platform (SSP) operably connected to the DSP, the advertisement display notification comprising an identifier of the end user, wherein on receipt of the advertisement display notification, the measurement platform stores the identifier of the exposed end user (“exposed user identifier”) in an exposed group of end users (“exposed users”) that have seen the winning advertisement, wherein the measurement platform is further configured to update an exposed group of the exposed users, wherein the measurement platform is further configured to update a control group of end users with similar statistical properties to the exposed group except that the control group members (“control users”) have not seen the winning advertisement, wherein the measurement platform is further configured to send the survey to the end user, wherein the measurement platform is further configured to receive a response to the survey from the end user, wherein the measurement platform is further configured to determine a metric measuring performance of the winning advertisement, wherein the measurement platform is further configured to send the metric to the client DSP.

2. The measurement platform of claim 1, wherein the end user comprises one or more of a control user and an exposed user.

3. The measurement platform of claim 1, wherein the measurement platform receives the advertisement display notification from the user device.

4. The measurement platform of claim 1, further comprising a data platform configured to store data usable by the measurement platform; a survey server operably connected to the data platform, the survey server configured to request the survey from the data platform; a control group builder operably connected to the data platform, the control group builder configured to update the control group with similar statistical properties to the exposed group; a control logic block operably connected to the survey server, the control logic block configured to receive the survey from the survey server; and a display and response logger operably connected to the data platform.

5. The measurement platform of claim 4, wherein the display and response logger is configured to receive the survey response from both the control user and from the exposed user.

6. The measurement platform of claim 5, wherein the display and response logger is further configured to store data regarding display on the user device of the winning advertisement.

7. The measurement platform of claim 6, wherein the display and response logger is further configured to log the completed end user response to the survey.

8. The measurement platform of claim 7, wherein the data platform comprises an exposed group storage configured to store the exposed group, a survey storage configured to store surveys to be sent to the end users when the survey storage receives a survey request from the survey server, a profile storage configured to store an end user profile, the end user profile comprising a set of features associated with the end user, and a control group storage configured to store an identifier of a control user (“control user identifier”).

9. The measurement platform of claim 8, wherein updating the exposed group comprises creating the exposed group if it does not already exist.

10. The measurement platform of claim 9, wherein updating the exposed group comprises storing an exposed user identifier.

11. The measurement platform of claim 1, wherein updating the control group comprises storing the control user identifier.

12. The measurement platform of claim 1, wherein updating the control group comprises creating the control group if it does not already exist.

13. The measurement platform of claim 8, wherein the profile storage is configured to store the end user profiles of all exposed users.

14. The measurement platform of claim 8, wherein, the profile storage is configured to store the end user profiles of all control users.

15. The measurement platform of claim 8, wherein the survey storage is further configured to send the requested survey to the survey server.

16. The measurement platform of claim 1, wherein the display and response logger is further configured to update the exposed group.

17. The measurement platform of claim 8, wherein the exposed group storage is further configured to receive an advertisement display notification comprising an exposed user identifier.

18. The measurement platform of claim 17, wherein the exposed group storage, on receipt of the advertisement display notification, stores the exposed user identifier in the exposed group.

19. The measurement platform of claim 17, wherein the exposed group storage is further configured to update the exposed group after the exposed group storage receives a new exposed user identifier.

20. The measurement platform of claim 19, wherein the exposed group storage is further configured to update the exposed group in real-time after receiving the new exposed user identifier.

21. The measurement platform of claim 1, wherein the control group builder updates the control group in real-time.

22. The measurement platform of claim 21, wherein the display and response logger is further configured to receive a response completed by the end user to the survey.

23. The measurement platform of claim 22, wherein the display and response logger is further configured to store the completed survey response in the profile storage.

24. The measurement platform of claim 1, wherein the end user is operably connected to the measurement platform.

25. The measurement platform of claim 8, wherein the control logic block is configured, upon receiving an advertisement request from the end user, the end user having an end user identifier in one or more of the control group storage and the exposed group storage, to request a survey from the survey server.

26. The measurement platform of claim 25, wherein the survey server is further configured to retrieve the survey from the survey storage and to send the survey to the control logic block.

27. The measurement platform of claim 26, wherein the control logic block sends the survey to the end user.

28. The measurement platform of claim 1, wherein the control logic block is further configured to send the survey to one or more of the control user and the exposed user.

29. The measurement platform of claim 4, wherein the control logic block is further configured, upon receiving an advertisement request copy from the SSP, to send the survey to the end user by sending to the SSP a measurement platform bid that wins the auction, the measurement platform bid comprising an amount of money the measurement platform offers to pay for the opportunity to display the survey on the user device, the measurement platform bid further comprising the survey.

30. The measurement platform of claim 1, wherein the report builder is configured to determine the metric.

31. The measurement platform of claim 30, wherein the report builder uses the completed survey responses to determine the metric.

32. The measurement platform of claim 31, wherein the metric comprises a difference between exposed group responses and control group responses.

33. The measurement platform of claim 32, wherein the report builder is configured to send the metric to the client DSP.

34. The measurement platform of claim 4, wherein the control group builder is further configured, using one or more of a feature of the control group and a feature of the exposed group, to determine similarity of the control group and the exposed group.

35. The measurement platform of claim 34, wherein the control group builder is further configured to determine the similarity by determining an actual index vector, wherein the actual index vector comprises a difference between the end user profiles corresponding to the exposed user and the end user profiles corresponding to the control user.

36. The measurement platform of claim 35, wherein an actual index vector component of 0 for a feature of interest indicates that the feature is equally represented in the control group and the exposed group, wherein an actual index vector component greater than 0 indicates that the feature of interest is under-represented in the control group relative to the exposed group, and wherein an actual index vector component less than 0 indicates that the feature of interest is over-represented in the control group relative to the exposed group.

37. The measurement platform of claim 36, wherein the control group builder selects from the profile storage an end user profile that minimizes a difference between the actual index vector and an ideal index vector, wherein the ideal index vector comprises a vector having a length equal to a length of the actual index vector, wherein each element of the ideal index vector equals 0.

38. The measurement platform of claim 37, wherein the difference between the actual index vector and the ideal index vector is a measure of a difference between the exposed user profiles and the control user profiles.

39. The measurement platform of claim 38, wherein the control group builder selects from the profile storage the control user profile that has similar statistical properties to the exposed user profile.

40. The measurement platform of claim 1, wherein the measurement platform receives the advertisement display notification directly from the client DSP.

41. A method for measuring effectiveness of an advertisement using a measurement platform, the method comprising:
receiving, by the measurement platform, the measurement platform configured to measure performance of an advertisement, the measurement platform comprising a demand-side platform (DSP), the measurement platform further comprising a profile storage configured to store an end user profile, the end user profile comprising a set of features associated with the end user, the measurement platform further comprising a control group storage configured to store an identifier of a control user (“control user identifier”), the measurement platform further comprising a control group builder operably connected to the data platform, the control group builder configured to update the control group with similar statistical properties to an exposed group of end users (“exposed users”) that have seen the winning advertisement, an advertisement display notification notifying the measurement platform that a device under control of the end user (“user device”) has displayed to the end user a winning advertisement from a client DSP, the client DSP comprising a DSP of a client of the measurement platform, the winning advertisement having won an auction run by a supply-side platform (SSP) operably connected to the DSP, the advertisement display notification comprising an identifier of the end user;
storing, by the measurement platform, the identifier of the exposed end user (“exposed user identifier”) in the exposed group;
updating, by the measurement platform, the exposed group;
updating, by the control group builder, with a new control user identifier, a control group of end users with similar statistical properties to the exposed group except that the control group members (“control users”) have not seen the winning advertisement;
storing, by the control group builder, the identifier of the new control user (“control user identifier”) in the control group storage;
receiving, by the measurement platform, an advertisement request copy from the SSP;
sending, by the measurement platform, to the end user, a survey configured to measure performance of the advertisement;
receiving, by the measurement platform, a response to the survey from the end user;
determining, by the measurement platform, a metric measuring performance of the winning advertisement; and
sending, by the measurement platform, the metric to the client DSP.

42. The method of claim 41, wherein updating the exposed group comprises creating the exposed group if it does not already exist.

43. The method of claim 41, wherein updating the exposed group comprises storing the exposed user identifier.

44. The method of claim 41, wherein updating the control group comprises creating the control group if it does not already exist.

45. The method of claim 41, wherein updating the control group comprises storing the control user identifier.

46. The method of claim 41, wherein the step of updating the exposed group comprises updating the exposed group after receiving a new exposed user identifier.

47. The method of claim 41, wherein the step of updating the exposed group further comprises updating the exposed group in real-time.

48. The method of claim 41, wherein the step of updating the control group further comprises updating the control group in real-time.

49. The method of claim 41, wherein the step of sending the survey comprises sending the survey to one or more of the control user and the exposed user.

50. The method of claim 41, wherein the step of sending the survey to the end user comprises, by the measurement platform, upon receiving an advertisement request copy from the SSP, sending to the SSP a measurement platform bid that wins the auction, the measurement platform bid comprising an amount of money the measurement platform offers to pay for the opportunity to display on the user device a survey configured to measure performance of the advertisement, the measurement platform bid further comprising the survey.

51. The method of claim 41, wherein the determining step comprises using a difference between exposed group responses and control group responses.

52. The method of claim 41, wherein the step of updating the control group comprises an additional sub-step of:
using one or more of a feature of the control group and a feature of the exposed group, determining similarity of the control group and the exposed group.

53. The method of claim 52, wherein the step of updating the control group comprises an additional sub-step, performed after the determining similarity sub-step, of:
determining the similarity by determining an actual index vector, wherein the actual index vector comprises a difference between the end user profiles corresponding to the exposed user and the end user profiles corresponding to the control user.

54. The method of claim 53, wherein the method further comprises an additional sub-step, performed after the sub-step of determining the actual index vector, of:
selecting an end user profile that minimizes a difference between the actual index vector and an ideal index vector, wherein the ideal index vector comprises a vector having a length equal to a length of the actual index vector, wherein each element of the ideal index vector equals 0.

55. The method of claim 54, wherein the sub-step of minimizing a difference between the actual index vector and an ideal index vector comprises selecting the end user profile that minimizes a statistical difference between the control group and the exposed group.

56. The method of claim 55, wherein an actual index vector component of 0 for a feature of interest indicates that the feature is equally represented in the control group and the exposed group, wherein an actual index vector component greater than 0 indicates that the feature of interest is under-represented in the control group relative to the exposed group, and wherein an actual index vector component less than 0 indicates that the feature of interest is over-represented in the control group relative to the exposed group.

57. The method of claim 41, wherein the step of updating the control group comprises the following sub-steps:
retrieving, by the control group builder, a selected portion of the exposed user identifiers;
retrieving, by the control group builder, a selected portion of the control user identifiers;
retrieving, by the control group builder, a selected portion of the end user profiles comprised in the profile storage;
encoding, by the control group builder, an end user profile into a binary feature vector, wherein at least one element of the binary feature vector equals 0 or 1;
sorting, by the control group builder, the binary feature vector into one of a group comprising exposed binary feature vectors (“an exposed binary feature vector group”), a group comprising control binary feature vectors (“a control binary feature vector group”), and a control pool comprising all available binary feature vectors that are not comprised in one or more of the exposed binary feature vector group and the control binary feature vector group;
determining, by the control group builder, using the exposed binary feature vector group and using the control binary feature vector group, an actual index vector, the actual index vector comprising a measure of a difference between the binary feature vectors corresponding to the exposed users (“exposed binary feature vectors”) and the binary feature vectors corresponding to the control users (“control binary feature vectors”);
determining, by the control group builder, a dot product between the actual index vector and a binary feature vector comprised in the control pool;
storing, by the control group builder, the dot product in the control group storage;
selecting, by the control group builder, a best control binary feature vector having a maximum value of the dot product; and
transferring, by the control group builder, the best control binary feature vector from the control pool to the control group.

58. A method for measuring effectiveness of an advertisement using a measurement platform, the method comprising:
receiving, by the measurement platform, the measurement platform configured to measure performance of an advertisement, the measurement platform comprising a demand-side platform (DSP), the measurement platform further comprising a profile storage configured to store an end user profile, the end user profile comprising a set of features associated with the end user, the measurement platform further comprising a control group storage configured to store an identifier of a control user (“control user identifier”), the measurement platform further comprising a control group builder operably connected to the data platform, the control group builder configured to update the control group with similar statistical properties to an exposed group of end users (“exposed users”) that have seen the winning advertisement, an advertisement display notification notifying the measurement platform that a device under control of the end user (“user device”) has displayed to the end user a winning advertisement from a client DSP, the client DSP comprising a DSP of a client of the measurement platform, the winning advertisement having won an auction run by a supply-side platform (SSP) operably connected to the DSP, the advertisement display notification comprising an identifier of the end user;
storing, by the measurement platform, the identifier of the exposed end user (“exposed user identifier”) in the exposed group;
updating, by the exposed group storage, the exposed group;
retrieving, by the control group builder, a selected portion of the exposed user identifiers;
retrieving, by the control group builder, a selected portion of the control user identifiers;
retrieving, by the control group builder, a selected portion of the end user profiles comprised in the profile storage;
encoding, by the control group builder, an end user profile into a binary feature vector, wherein at least one element of the binary feature vector equals 0 or 1;
sorting, by the control group builder, the binary feature vector into one of a group comprising exposed binary feature vectors (“an exposed binary feature vector group”), a group comprising control binary feature vectors (“a control binary feature vector group”), and a control pool comprising all available binary feature vectors that are not comprised in one or more of the exposed binary feature vector group and the control binary feature vector group;
determining, by the control group builder, using the exposed binary feature vector group and using the control binary feature vector group, an actual index vector, the actual index vector comprising a measure of a difference between the binary feature vectors corresponding to the exposed users (“exposed binary feature vectors”) and the binary feature vectors corresponding to the control users (“control binary feature vectors”);
determining, by the control group builder, a dot product between the actual index vector and a binary feature vector comprised in the control pool;
storing, by the control group builder, the dot product in the control group storage;
selecting, by the control group builder, a best control binary feature vector having a maximum value of the dot product;
transferring, by the control group builder, the best control binary feature vector from the control pool to the control group;
storing, by the control group builder, the identifier of the new control user (“control user identifier”) in the control group storage;
determining, by the measurement platform, that a size of the control group does not comprise at least a required control group size; and
returning, by the measurement platform, to the step of retrieving all available exposed user identifiers.

59. The method of claim 58, wherein the encoding step comprises encoding the end user profile using one-hot-encoding.

60. A method for measuring effectiveness of an advertisement using a measurement platform, the method comprising:
receiving, by the measurement platform, the measurement platform configured to measure performance of an advertisement, the measurement platform comprising a demand-side platform (DSP), the measurement platform further comprising a profile storage configured to store an end user profile, the end user profile comprising a set of features associated with the end user, the measurement platform further comprising a control group storage configured to store an identifier of a control user (“control user identifier”), the measurement platform further comprising a control group builder operably connected to the data platform, the control group builder configured to update the control group with similar statistical properties to an exposed group of end users (“exposed users”) that have seen the winning advertisement, an advertisement display notification notifying the measurement platform that a device under control of the end user (“user device”) has displayed to the end user a winning advertisement from a client DSP, the client DSP comprising a DSP of a client of the measurement platform, the winning advertisement having won an auction run by a supply-side platform (SSP) operably connected to the DSP, the advertisement display notification comprising an identifier of the end user;
storing, by the measurement platform, the identifier of the exposed end user (“exposed user identifier”) in the exposed group;
updating, by the exposed group storage, the exposed group;
retrieving, by the control group builder, a selected portion of the exposed user identifiers;
retrieving, by the control group builder, a selected portion of the control user identifiers;
retrieving, by the control group builder, a selected portion of the end user profiles comprised in the profile storage;
encoding, by the control group builder, an end user profile into a binary feature vector, wherein at least one element of the binary feature vector equals 0 or 1;
sorting, by the control group builder, the binary feature vector into one of a group comprising exposed binary feature vectors (“an exposed binary feature vector group”), a group comprising control binary feature vectors (“a control binary feature vector group”), and a control pool comprising all available binary feature vectors that are not comprised in one or more of the exposed binary feature vector group and the control binary feature vector group;
determining, by the control group builder, using the exposed binary feature vector group and using the control binary feature vector group, an actual index vector, the actual index vector comprising a measure of a difference between the binary feature vectors corresponding to the exposed users (“exposed binary feature vectors”) and the binary feature vectors corresponding to the control users (“control binary feature vectors”);
determining, by the control group builder, a dot product between the actual index vector and a binary feature vector comprised in the control pool;
storing, by the control group builder, the dot product in the control group storage;
selecting, by the control group builder, a best control binary feature vector having a maximum value of the dot product;
transferring, by the control group builder, the best control binary feature vector from the control pool to the control group;
storing, by the control group builder, the identifier of the new control user (“control user identifier”) in the control group storage;
determining, by the measurement platform, that a size of the control group comprises at least a required control group size;
receiving, by the measurement platform, an advertisement request copy from the SSP;
sending, by the measurement platform, to the SSP a measurement platform bid that wins the auction, the measurement platform bid comprising an amount of money the measurement platform offers to pay for the opportunity to display on the user device a survey configured to measure on behalf of the client DSP performance of the winning advertisement the measurement platform bid further comprising the survey;
sending, by the measurement platform, the survey to the end user;
receiving, by the measurement platform, a response to the survey from the end user;
determining, by the measurement platform, a metric measuring performance of the winning advertisement; and
sending, by the measurement platform, the metric to the client DSP.

61. The method of claim 60, wherein the encoding step comprises encoding the end user profile using one-hot-encoding.

62. A method for measuring effectiveness of an advertisement using a measurement platform, the method comprising:
receiving, by the measurement platform, the measurement platform configured to measure performance of an advertisement, the measurement platform comprising a demand-side platform (DSP), the measurement platform further comprising a profile storage configured to store an end user profile, the end user profile comprising a set of features associated with the end user, the measurement platform further comprising a control group storage configured to store an identifier of a control user (“control user identifier”), the measurement platform further comprising a control group builder operably connected to the data platform, the control group builder configured to update the control group with similar statistical properties to an exposed group of end users (“exposed users”) that have seen the winning advertisement, an advertisement display notification notifying the measurement platform that a device under control of the end user (“user device”) has displayed to the end user a winning advertisement from a client DSP, the client DSP comprising a DSP of a client of the measurement platform, the winning advertisement having won an auction run by a supply-side platform (SSP) operably connected to the DSP, the advertisement display notification comprising an identifier of the end user;
storing, by the measurement platform, the identifier of the exposed end user (“exposed user identifier”) in the exposed group;
updating, by the exposed group storage, the exposed group;
retrieving, by the control group builder, a selected portion of the exposed user identifiers;
retrieving, by the control group builder, a selected portion of the control user identifiers;
retrieving, by the control group builder, a selected portion of the end user profiles comprised in the profile storage;
encoding, by the control group builder, using one-hot encoding, an end user profile into a binary feature vector, wherein at least one element of the binary feature vector equals 0 or 1;
sorting, by the control group builder, the binary feature vector into one of a group comprising exposed binary feature vectors (“an exposed binary feature vector group”), a group comprising control binary feature vectors (“a control binary feature vector group”), and a control pool comprising all available binary feature vectors that are not comprised in one or more of the exposed binary feature vector group and the control binary feature vector group;
determining, by the control group builder, using the exposed binary feature vector group and using the control binary feature vector group, an actual index vector, the actual index vector comprising a measure of a difference between the binary feature vectors corresponding to the exposed users (“exposed binary feature vectors”) and the binary feature vectors corresponding to the control users (“control binary feature vectors”), using an equation (1):
$$actual\_index {\_vector}_{i} = ln ( \frac{( {expCount}_{i}^{⋆} numConBFVectors )}{( {conCount}_{{i}^{⋆}} numExpBFVectors )} ) , \qquad ( 1 )$$
wherein:
expCountᵢ=a count of 1's comprised in an ith element of the exposed binary feature vector;
conCountᵢ=a count of 1's comprised in respective ith element of the control binary feature vectors;
numConBFVectors=number of binary feature vectors comprised in the control group; and
numExpBFVectors=number of binary feature vectors comprised in the exposed group;
determining, by the control group builder, a dot product between the actual index vector and a binary feature vector comprised in the control pool;
storing, by the control group builder, the dot product in the control group storage;
selecting, by the control group builder, a best control binary feature vector having a maximum value of the dot product;
transferring, by the control group builder, the best control binary feature vector from the control pool to the control group;
storing, by the control group builder, the identifier of the new control user (“control user identifier”) in the control group storage;
determining, by the measurement platform, that a size of the control group does not comprise at least a required control group size; and
returning, by the measurement platform, to the step of retrieving all available exposed user identifiers.

63. A method for measuring effectiveness of an advertisement using a measurement platform, the method comprising:
receiving, by the measurement platform, the measurement platform configured to measure performance of an advertisement, the measurement platform comprising a demand-side platform (DSP), the measurement platform further comprising a profile storage configured to store an end user profile, the end user profile comprising a set of features associated with the end user, the measurement platform further comprising a control group storage configured to store an identifier of a control user (“control user identifier”), the measurement platform further comprising a control group builder operably connected to the data platform, the control group builder configured to update the control group with similar statistical properties to an exposed group of end users (“exposed users”) that have seen the winning advertisement, an advertisement display notification notifying the measurement platform that a device under control of the end user (“user device”) has displayed to the end user a winning advertisement from a client DSP, the client DSP comprising a DSP of a client of the measurement platform, the winning advertisement having won an auction run by a supply-side platform (SSP) operably connected to the DSP, the advertisement display notification comprising an identifier of the end user;
storing, by the measurement platform, the identifier of the exposed end user (“exposed user identifier”) in the exposed group;
updating, by the exposed group storage, the exposed group;
retrieving, by the control group builder, a selected portion of the exposed user identifiers;
retrieving, by the control group builder, a selected portion of the control user identifiers;
retrieving, by the control group builder, a selected portion of the end user profiles comprised in the profile storage;
encoding, by the control group builder, using one-hot-encoding, an end user profile into a binary feature vector, wherein at least one element of the binary feature vector equals 0 or 1;
sorting, by the control group builder, the binary feature vector into one of a group comprising exposed binary feature vectors (“an exposed binary feature vector group”), a group comprising control binary feature vectors (“a control binary feature vector group”), and a control pool comprising all available binary feature vectors that are not comprised in one or more of the exposed binary feature vector group and the control binary feature vector group;
determining, by the control group builder, using the exposed binary feature vector group and using the control binary feature vector group, an actual index vector, the actual index vector comprising a measure of a difference between the binary feature vectors corresponding to the exposed users (“exposed binary feature vectors”) and the binary feature vectors corresponding to the control users (“control binary feature vectors”), using an equation (1):
$$actual\_index {\_vector}_{i} = ln ( \frac{( {expCount}_{i}^{⋆} numConBFVectors )}{( {conCount}_{{i}^{⋆}} numExpBFVectors )} ) , \qquad ( 1 )$$
wherein:
expCountᵢ=a count of 1's comprised in an ith element of the exposed binary feature vector;
conCountᵢ=a count of 1's comprised in respective ith element of the control binary feature vectors;
numConBFVectors=number of binary feature vectors comprised in the control group; and
numExpBFVectors=number of binary feature vectors comprised in the exposed group;
determining, by the control group builder, a dot product between the actual index vector and a binary feature vector comprised in the control pool;
storing, by the control group builder, the dot product in the control group storage;
selecting, by the control group builder, a best control binary feature vector having a maximum value of the dot product;
transferring, by the control group builder, the best control binary feature vector from the control pool to the control group;
storing, by the control group builder, the identifier of the new control user (“control user identifier”) in the control group storage;
determining, by the measurement platform, that a size of the control group comprises at least a required control group size;
receiving, by the measurement platform, an advertisement request copy from the SSP;
sending, by the measurement platform, to the SSP a measurement platform bid that wins the auction, the measurement platform bid comprising an amount of money the measurement platform offers to pay for the opportunity to display on the user device a survey configured to measure on behalf of the client DSP performance of the winning advertisement the measurement platform bid further comprising the survey;
sending, by the measurement platform, the survey to the end user;
receiving, by the measurement platform, a response to the survey from the end user;
determining, by the measurement platform, a metric measuring performance of the winning advertisement; and
sending, by the measurement platform, the metric to the client DSP.
